(19) United States
(12) Patent Application Publication
(10) Pub. No.: US 2024/0292829 A1
(43) Pub. Date: Sep. 5, 2024

(54) NON-POWERED INSECT REPELLENT DEVICE AND METHODS

(71) Applicant: United Industries Corporation, Earth City, MO (US)

(72) Inventors: Alex J. Wall, Earth City, MO (US); Christina Lee Brown, Earth City, MO (US); Josh Matta, Earth City, MO (US); Amber Martin, Earth City, MO (US); Hemant Betrabet, Earth City, MO (US); Duane Kaufman, Earth City, MO (US); Bryon Sande, Earth City, MO (US); Mike Andrew, Earth City, MO (US); Chris Eby, Earth City, MO (US); Doug Birkholz, Earth City, MO (US); Gopal P. Ananth, Racine, WI (US)

(21) Appl. No.: 18/573,033

(22) PCT Filed: Jun. 21, 2022
(86) PCT No.: PCT/IB2022/055771

§ 371 Date: Dec. 21, 2023

Related U.S. Application Data
(60) Provisional application No. 63/213,510, filed on Jun. 22, 2021.
(60) Provisional application No. 63/343,392, filed on May 18, 2022.

(51) Int. Cl. A01M 29/12

(52) U.S. Cl. CPC A01M 29/12; A01M 2200/01

(57) ABSTRACT

A non-powered insect repellent device can include a heating element, a removable cover, an insect repellent element, and a housing. The heating element can include a chemical compound configured to generate heating energy via an exothermic reaction. The removable cover can be coupled with a portion of the heating element. The portion of the heating element can be exposed to air with the removable cover at least partially removed from the heating element. The insect repellent element can emanate insect repellent solution in response to the heating energy. The housing can define a cavity, a first opening, and a second opening. Air can flow through the first opening to the heating element. The housing is configured to provide vaporized insect repellent solution through the second opening.

### BACKGROUND

Insects such as mosquitoes are vectors for the transmission of various diseases in humans. Diseases such as Malaria, West Nile Virus (West Nile Virus), yellow Fever and Zika Fever (Zika Fever) are all readily transmitted by mosquitoes. Once spread, these diseases not only seriously affect the health of the general population, but also may be life threatening to the infected person with relatively poor immunity. To prevent and control outbreaks of mosquito-borne diseases, it is important to reduce contact between mosquitoes and the human body, thereby reducing the likelihood of transmitting the disease through mosquito bites. The application of synthetic or natural repellents to specific surfaces (such as exposed skin and clothes) has long been used to deter or prevent the settling of mosquitoes. N, N-diethyl-m-toluamide (DEET), developed more than a decade ago, remains an effective chemical for the prevention of mosquitoes and similar insects. Picaridin, permethrin, geraniol, etc., are other compounds that have similar effects on mosquitoes. Although chemical repellents are superior in performance, they are not perfect solutions that provide long-term and reliable protection from mosquito bites. For example, the repellency of chemical repellents gradually diminishes, and 100% repellency may only last for about 30 minutes to 2 hours. To continue to be protected, the user must reapply the chemical insect repellent from time to time, usually directly on their skin or clothing.

### SUMMARY

One exemplary embodiment relates to a non-powered insect repellent device. The non-powered insect repellent device can include a heating element, a removable cover, an insect repellent element, and a housing. The heating element can include a chemical compound configured to generate heating energy via an exothermic reaction. The removable cover can be coupled with a portion of the heating element. The portion of the heating element can be exposed to air with the removable cover at least partially removed from the heating element. The insect repellent element can emanate insect repellent solution in response to the heating energy. The housing can define a cavity, a first opening, and a second opening. Air can flow through the first opening to the heating element. The housing is configured to provide vaporized insect repellent solution through the second opening.

Another exemplary embodiment relates to a non-powered insect repellent device. The non-powered insect repellent device can include a housing, an activant element, a heating element, and an insect repellent element. The housing can define a first opening fluidly coupled with a second opening and a cavity. The cavity can include a first chamber separated from a second chamber. The activant can be positioned within the first chamber. The heating element can be positioned within the second chamber. The heating element can include a chemical compound configured to generate heating energy via a chemical reaction with the activant. The insect repellent element can emanate insect repellent solution in response to the heating energy. Air can flow from the first opening to the second opening to provide the vaporized insect repellent solution through the second opening.

Another exemplary embodiment relates to a non-powered insect repellent device. The non-powered insect repellent device can include a housing including defining a cavity and at least one opening. The non-powered insect repellent device can include a heating element positioned within the cavity. The heating element can include a thermal material and a hydrogel material. The heating element can generate heating energy via a chemical reaction with an activant. The device can include an insect repellent element positioned within the cavity and proximate the at least one opening. The insect repellent element can emanate insect repellent vapor in response to the heating energy. The device can be configured for one-time use.

The invention is capable of other embodiments and of being carried out in various ways. Alternative exemplary embodiments relate to other features and combinations of features as may be recited herein.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a non-powered insect repellent device, according to example an embodiment.

FIG. 2 is a perspective view of a non-powered insect repellent device, according to an example embodiment.

FIGS. 3A-3B depict a non-powered insect repellent device, according to an example embodiment.

FIGS. 4A-4B depict a non-powered insect repellent device, according to an example embodiment.

FIGS. 5A-5C depict a non-powered insect repellent device, according to an example embodiment.

FIGS. 6A-6B depict a non-powered insect repellent device, according to an example embodiment.

FIG. 7A-7D depict a non-powered insect repellent device, according to an example embodiment.

FIG. 8A-8C depict non-powered insect repellent devices, according to an example embodiment.

FIGS. 9A-9B depict a non-powered insect repellent device, according to an example embodiment.

FIG. 10 is a perspective view of a non-powered insect repellent device, according to an example embodiment.

FIG. 11 is a perspective view of a non-powered insect repellent device, according to an example embodiment.

FIG. 12 is a perspective view of a non-powered insect repellent device, according to an example embodiment.

FIG. 13 is a perspective view of a non-powered insect repellent device, according to an example embodiment.

FIG. 14 is a perspective view of a non-powered insect repellent device, according to an example embodiment.

FIG. 15 is a perspective view of a non-powered insect repellent device, according to an example embodiment.

FIG. 16 is a perspective view of a non-powered insect repellent device, according to an example embodiment.

FIG. 17 is a perspective view of a non-powered insect repellent device, according to an example embodiment.

FIG. 18 is a perspective view of a non-powered insect repellent device, according to an example embodiment.

FIG. 19 is a perspective view of a non-powered insect repellent device, according to an example embodiment.

FIG. 20 is a perspective view of a non-powered insect repellent device, according to an example embodiment.

FIG. 21 is a perspective view of a non-powered insect repellent device, according to an example embodiment.

FIG. 22 is a perspective view of a non-powered insect repellent device, according to an example embodiment.

FIG. 23 is a perspective view of a non-powered insect repellent device, according to an example embodiment.

FIG. 24 is a perspective view of a non-powered insect repellent device, according to an example embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, the various exemplary embodiments disclosed herein relate to systems, apparatuses, and methods for insect repellency. For example, the present disclosure relates to non-powered insect repellent devices and methods. An insect repellent device can be non-powered such that electricity, batteries, gas or other powered sources are not required to activate an insect repellent compound. In one example embodiment there is device in combination with a volatile insect control chemical and a non-powered heating element, such that when initiated, the non-powered heating element will heat the substrate to expedite dispensing of the volatile insect control chemical.

As disclosed herein, various non-powered insect repellent devices and methods can use a wide variety of insect control ingredients (especially insect repellents). Insect repellents can include highly volatile synthetic pyrethroid esters. Other insect repellents can include volatile insecticides, volatile insect-repelling natural oils, volatile insect growth regulators, and mixtures thereof. Yet other related insect repellents can include as a non-exhaustive list compounds such as oil of lemon-eucalyptus, transfluthrin, metofluthrin, nootkatone, citronella, lemongrass, necronome, linalool, and combinations thereof. In these examples, an absorbant or semi-absorbant pad can be saturated with liquid formulations. In some examples, the non-powered insect repellent devices and methods can use solids, semi-solids, gel formulation, and impregnated materials, such as mesh or fiber and combinations thereof instead of or in addition to liquid repellents. A non-powered insect repellent device or method can use wicking of liquid formulation to contact a fabric or mesh surface that is in contact with the heat source, according to one example.

A heating element or a heater can include chemicals within a pouch that react when exposed to air or another chemical, where the reaction generates heat. These chemicals may include a variety of exothermic chemical reaction-based heating chemicals, according one example. The heater can also use chemicals that evolve heat when exposed to oxygen, such as chemicals that use or include iron/iron oxide-based powders. For example, a heater can use chemicals within a pouch including iron powder, a small amount of water, vermiculite, active carbon, and sodium chloride. In this example, when ambient air reaches the iron, as may occur when a cover is pulled off a permeable surface of the pouch, the iron can oxidize and generate heat as a result. In other related embodiments the heater can include chemicals within a pouch including iron powder, activated charcoal, sodium chloride and water. In yet other examples, magnesium, iron, and salt can be used where, when exposed to water, the chemical generates heat that can be used to disperse or dispense an insect repellent compound. The chemicals of the heater can include a saturated or super-saturated sodium acetate, according to another example.

The heating element or heater can include one or more chemicals in varying proportions and having varying formulas. For example, the heater can use chemicals including:

| Chemical | Percentage by weight |
|---|---|
| Iron Powder | 50-65% |
| Activated Charcoal | 7-10% |
| Sodium Chloride | 3-7% |
| Water | 30-40% |

In other examples, a water absorbent resin may be included in amounts, such as approximately 0.1% to approximately 0.4% by weight. One advantage of certain formulations is that certain formulations may be environmentally compatible and can be discarded without the need for specialized disposal, as may be required to avoid adverse environmental effect when other non-environmentally compatible chemicals are used.

In some examples, the heating element can have a chemistry including one or more chemical compositions that can cause an exothermic reaction or oxidation reaction to generate heating energy. For example, the heating element can have a chemistry including magnesium alloy, sodium chloride, and water. For example, magnesium alloy or sodium chloride can be activated by water or salt water to create an exothermic reaction. The heating element can have a chemistry including zinc powder, copper sulfate, and water. For example, zinc powder or copper sulfate can be activated by water to create an oxidation reaction that generates heating energy. The heating element can include a chemistry including calcium oxide and an electrolyte solution or water. For example, calcium oxide can be activated by an electrolyte solution to create an exothermic reaction. The heating element can have a chemistry including potassium salts and glycerol. For example, potassium salts such as potassium permanganate can be activated by glycerol to create an oxidation reaction. The heating element can have a chemical compound configured to produce a catalytic reaction. The heating element can have activated carbon. The heating element can have a chemistry including aluminum powder and silica. The heating element can include a chemical compound producing an acid and base reaction. The heating element can have a chemistry including calcium salts and water. The heating element can include a hydrogel material. For example, the heating element can include hydrogel beads that include polymeric materials such as superabsorbent polymers. The hydrogel beads can be saturated with moisture (e.g., water). An exothermic reaction of the heating element can cause the hydrogel material to evaporate and provide water to the heating element. The moisture can be consumed during the exothermic reaction to prolong the exothermic reaction or increase a maximum temperature of the exothermic reaction. In some examples, the moisture contained in hydrogel material can provide fuel for the exothermic reaction. For example, some heating elements can be activated by water, in which case the hydrogel beads can evaporate as the heating element is heated to provide additional water to continue (e.g., increase, prolong, extend) an exothermic reaction. In some instances, the exothermic reaction can be started by providing other water (e.g., water not in hydrogel form), which initiates an exothermic reaction, which can cause the hydrogels to evaporate, which can cause the hydrogels to provide additional water to the heating element to continue the exothermic reaction.

In other related embodiments, the volatile and non-powered heating component is disposed in a container, such as a bag or pouch. In one example, the bag or pouch can comprise a mixed polymeric material. In other examples, the bag or pouch can comprise a natural fiber, such as a cotton material. In yet other examples, the bag or pouch can comprise a blend of polymeric material and natural fiber materials. In other examples, the heating element can be a sheet, a pad, or an amount of powder contained in a pouch, bag, or other reservoir. Depending on the chemistry of the heating element, the heating element can be of varying sizes. For example, heating elements having a relatively high energy concentration (e.g., heating elements generating a relatively high amount of heating energy by weight or volume) can be relatively small to meet the needs of the non-powered insect repellent device. Relatedly, heating elements having a relatively low energy concentration (e.g., heating elements generating a relatively low amount of heating energy by weight or volume) can be relatively large to meet the needs of the non-powered insect repellent device. For example, heating elements using a zinc-based chemistries or magnesium-based chemistries can be relatively small compared to heating elements using iron-based chemistries. In various embodiments, the amount of certain chemicals or compounds within the heating element can be selected based on a desired temperature profile or heating time profile. For example, certain chemistries can result in a greater temperature profile (e.g., higher maximum temperatures), but a shorter time profile (e.g., an oxidation or exothermic reaction will cease in a shorter amount of time). Other chemistries can result in a greater time profile but a lesser temperature profile. Accordingly, the chemical composition of a heating element can be selected based on specific temperature or time requirements for a particular non-powered insect repellent device.

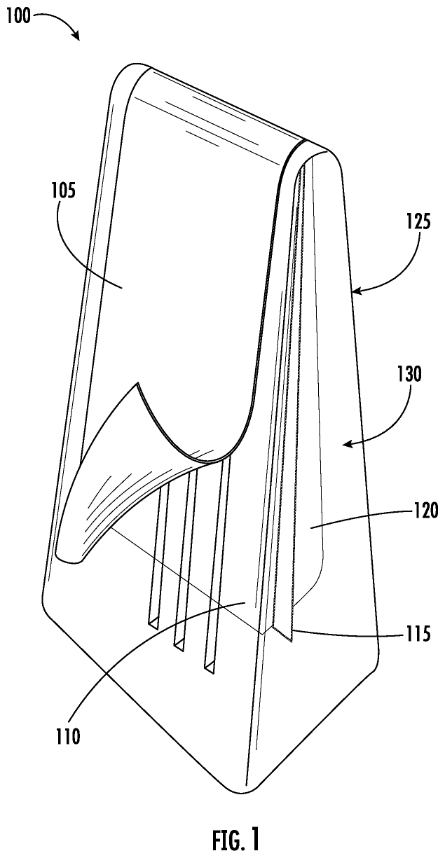

Referring to FIG. 1, a non-powered insect repellent device 100 including at least one attached cover 105 is shown. The attached cover 105 can be used to keep the device sealed (i.e., prevent any heating element 110 or other chemicals from oxygen exposure) until the device 100 is ready to be activated or used. In at least this example embodiment, at least one metal sheet 115 can be disposed between at least one heating element 110 and at least one active ingredient 120 (e.g., an insect repellent). The metal sheet 115 can facilitate the even heating of the permeated substrate. More specifically, the metal sheet 115 can be an intermediary metallic sheet that provides a means for even distribution of heat to emit more uniform insect repellency over time. In at least this example, the non-powered insect repellent device 100 can include a housing 125 or container defining an interior cavity 130, where the heating element 110 and active ingredient 120 are positioned within the interior cavity 130. The device 100 of FIG. 1 can include an active ingredient 120 including an absorbent pad of different sizes that is saturated or semi-saturated with an insect repellent chemical. The device 100 of FIG. 1 can also use a heating element 110 of various sizes containing various amounts of reactive chemicals (e.g., chemicals producing an exothermic-reaction). By varying the amount of insect repellent in the active ingredient 120 and the amount of heat generated by a heating element 110, the activated non-powered insect repellent device 100 may dispense or disperse insect repellent for a varying amount of time or at a varying degree of insect repellent potency, for example. In other related embodiments the non-powered insect repellent device can include a press to activate feature that, when pressed, punctures holes in a cover (e.g., the attached cover 105) to expose the heating element to oxygen, thereby causing the heating element 110 to generate heat via exothermic reaction, for example.

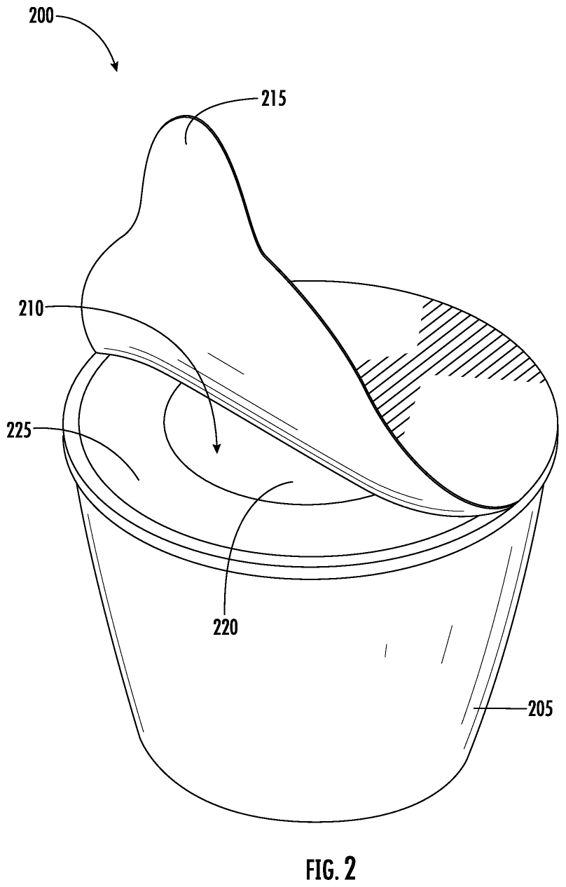

Referring now to FIG. 2, a non-powered insect repellent device 200 is shown, according to another example. The non-powered insect repellent device 200 of FIG. 2 includes a housing 205 defining an interior cavity 210 and a detachable lid 215 that, when removed (or peeled), activates the device 200 for use. In at least this example, a heating element 220 including an exothermic chemical compound can be activated when the lid is peeled back from the housing, exposing both the heating element (and exothermic compound) and an active ingredient 225 (e.g., an insect repellent) to oxygen. In one example embodiment the exothermic compound is positioned proximate a center of the interior cavity 210 of the housing 205. In at least this example, the insect repellent compound 225 is along the external perimeter of the interior cavity 210 of the housing 205. In another example, a saturated or semi-saturated pad containing insect repellent 225 may be positioned proximate the center of the interior cavity 210. In this example, the heating element 220 may be positioned along an external perimeter of the interior cavity 210 such that the exothermic compound of the heating element 220 at least partially surrounds the insect repellent 225. In this particular embodiment, the consumer can use the tactile sense of heat (that emanates through the housing 205, for example) to determine that the heating element 220 is still generating heat, which can imply that insect repellent 225 is still being dispensed or dispersed from the device to provide protective coverage from insects. In other related embodiments the lid 215 can be resealed, thereby reducing or substantially eliminating oxygen exposure to the exothermic compound. Because the heating element 220 may comprise an exothermic compound that reacts to oxygen exposure, starving the heating element 220 of oxygen can stop or substantially reduce the rate of the exothermic reaction when the lid 215 is resealed. Accordingly, the non-powered insect repellent device 200 of FIG. 2 can be a reusable insect repellent device 200 at least in circumstances where a user or consumer reseals the lid 215 to stop an exothermic reaction before either of the exothermic compounds of the heating element 220 or active insect repellent ingredient 225 is fully consumed. In other related embodiments, the device 200 could further comprise a color changing means to provide the user an indication that the insect repellent device 200 is activated. For example, the housing 205 could comprise a heat-activated material that changes color when the heating element 220 is active and insect repellent 225 is being dispersed.

In other example embodiments, the exothermic compound could be on the top or bottom of the housing 205. It should be appreciated that the disclosure herein, provides for other alternative options as well, such as a swirl or twist configuration between the heating element 220 and insect repellent compound 225 based on the efficiency and time desired to deliver active ingredients (e.g., insect repellent 225). In each of the aforementioned embodiments, the device 200 could further comprise a vent and or mesh layer on top that limits ability to access insect repellent compound or exothermic compound, and/or a vent or mesh layer around the perimeter to increase oxygen permeation through the device. It should further be appreciated that the housing 205 could be made from recyclable material such as plastic, paper, fiber or the like.

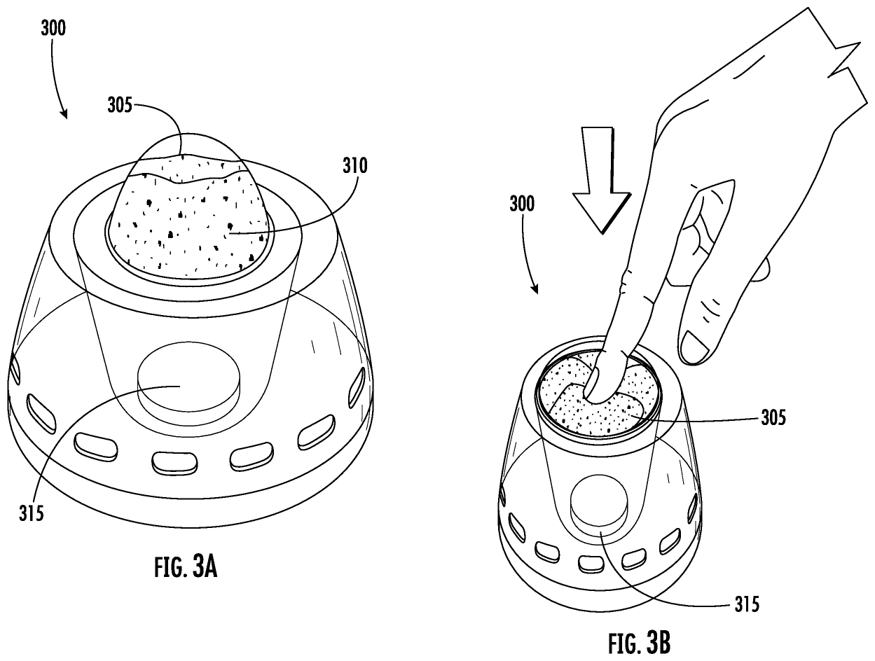

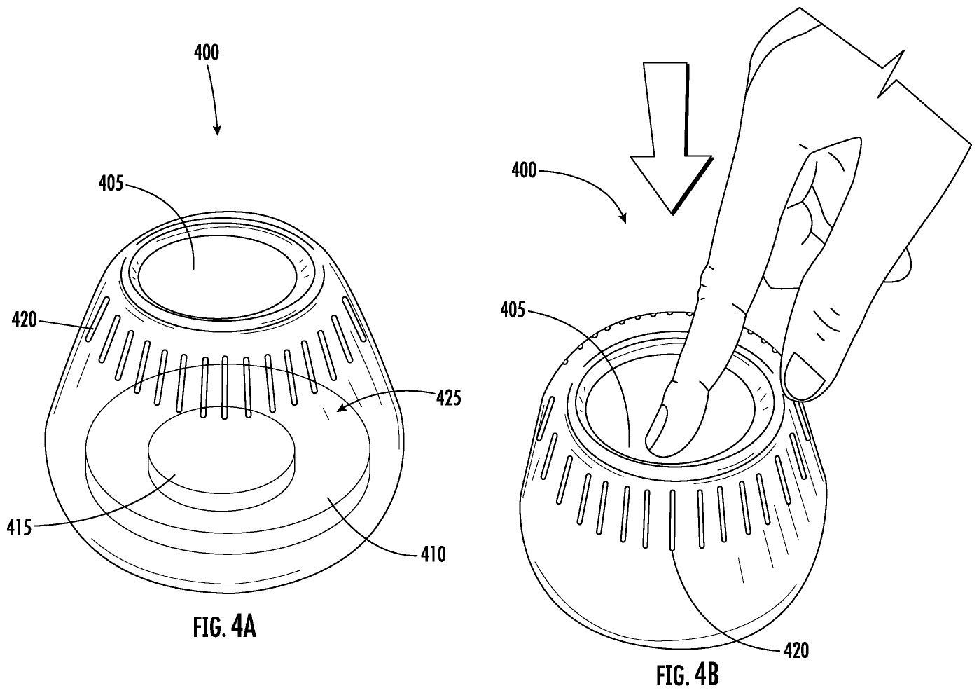

Referring now to FIGS. 3A-3B and 4A-4B, non-powered insect repellent devices 300 and 400 including a press-to-activate feature are shown. The non-powered insect repellent devices 300 and 400 can include a button 305, 405 that activates an exothermic compound of a heating element 310, 410 when pressed. In at least this example embodiment, an insect repellent element 315, 415 and/or the heating element 310, 410 can be formulated in a dry puck form factor. In at least these examples, the activation from force being applied to the heating element 310, 410 will initiate exposure of the exothermic compound of the heating element 310, 410 to oxygen. In some example, the heating element 310, 410 can be activated by pressing the button 305, 405 and exposing the exothermic compound of the heating element 310, 410 to air, by either releasing the heating powder from a closed compartment, or creating an opening for oxygen permeation. Referring specifically to FIG. 4, the insect repellent element 415 puck or pad having insect repellent compound and/or the heating element 410 can exposed to air when the button 405 is pressed. More specifically, at least one vent or slot 420 can open when the button 405 is depressed, where the vent or slot 420 exposes an interior cavity 425 of the non-powered insect repellent device 400 to oxygen. The button 405 of the device can be pressed again close the vent or slot 420, which stops oxygen from entering the interior cavity 425 of the device 400 and thereby prevents emanation of insect repellent from the insect repellent element 415. In this manner, these embodiments can use a mechanical “off/on” application to open and close the vent or slot 420 in order to regulate the oxygen provided to the insect repellent element 415 or the heating element 410. When in use, pressing the button 405 opens the vent or slot 420, allowing air to enter the interior cavity 425, which activates a pouch, puck, etc. containing a heating element or other active ingredient (e.g., the heating element 410). Activating the heating element 410 or active ingredient can cause the insect repellent element 415 to emanate from the interior cavity 425. In one example, the non-powered insect repellent device 400 can have a first button positioned proximate a top of the device and a second button positioned proximate a bottom of the device 400. The first button can be pressed to activate the device 400 (e.g., to open the vent or slot 420) and the second button can be pressed to deactivate the device (e.g., to close the vent or slot 420). In various examples, the heating element could be contained in the interior cavity 425 such that is activated when at least one button 405 is pressed and released (e.g., the button does not remain depressed).

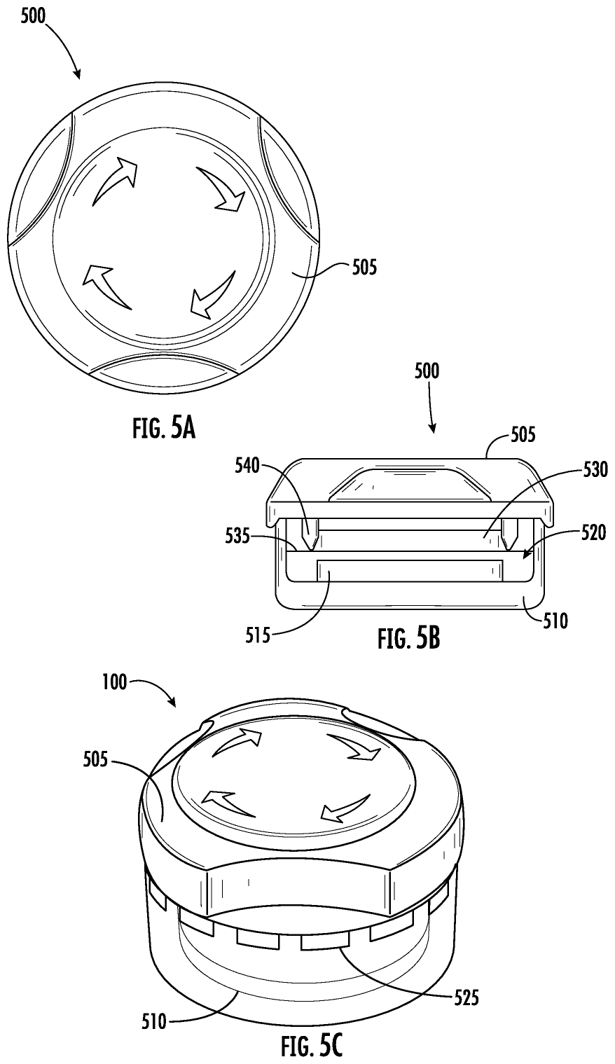

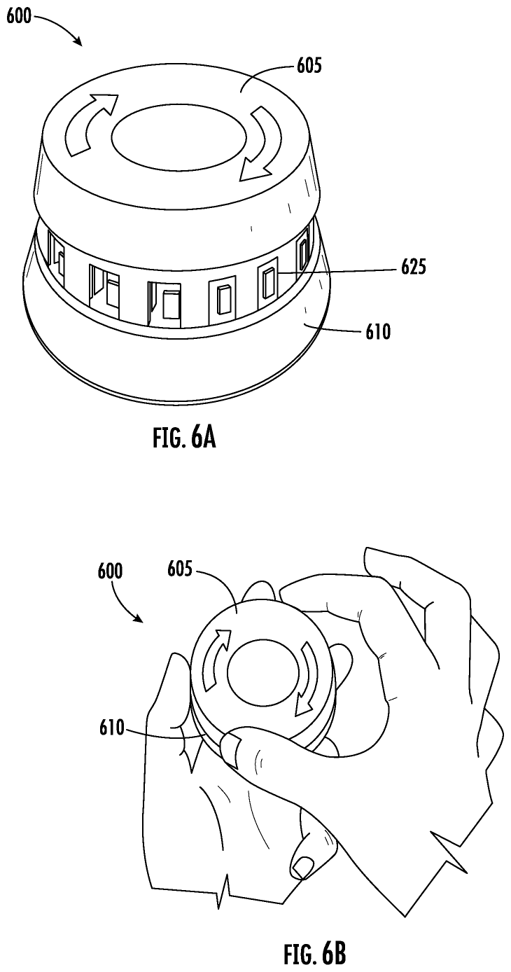

Referring now to FIGS. 5A-5B and 6A-6B, non-powered insect repellent devices 500 and 600 are shown including a first half 505, 605 rotatably coupled to a second half 510, 610. In one example, the first half 505, 605 may be twisted (e.g., rotated, turned) relative to the second half 510, 610 to open the device 500, 600 and activate a heating element 515 contained within a cavity 520 defined by the first half 505, 605 or the second half 510, 610. For example, the heating element 515 can include an exothermic compound that is activated when exposed to oxygen or other chemical. More specifically, the twisting of at least one of the first half 505, 605 and the second half 510, 610 relative to the other can open at least one vent 525, 625 on the second half 510, 610 (e.g., on a bottom of the device or on a side of the second half) or on the first half 505, 605 (e.g., on a top of the device or on a side of the first half), where the vent 525, 625 can allow air to flow into the cavity 520 defined by the first half 505, 605 and/or second half 510, 610. In these example embodiments, the device 500, 600 is configured for ease in turning the insect repellency on and off with twisting the first half 505, 605 or the second half 510, 610 of the device 500, 600. In various examples, the non-powered insect repellent device 500, 600 of FIGS. 5-6 is compact, and easy to use and re-use.

In some examples, the device 500, 600 can include a separating layer 535 (e.g., a foil) separating an insect repellent element 530 from the heating element 515. The separating layer 535 can be pierced by a protrusion 540 of the first half 505 to allow air that flows from the vent 525 to reach the heating element 515 to cause an exothermic reaction. In some examples, the heating element 515 (including an exothermic compound) or the insect repellent element 530 (e.g., a puck or absorbent pad that is saturated or semi-saturated with insect repellent) can be replaced within the first half 505, 605 or the second half 510, 610 once consumed. In this way, the non-powered insect repellent device 500, 600 can at least partially reusable. In various examples, at least one vent or opening 525, 625 on the first half 505, 605 or the second half 510, 610 can allow air to flow into the cavity 520 of the first half 505, 605 and/or the second half 510, 610, where the vent or opening 525, 625 can be positioned in a number of locations and manners. For example, the vent 525, 625 could be positioned at a bottom of the device 500, 600, along a side of the device 500, 600, on a top surface of the device 500, 600, or combination of these. As described above, the insect repellent and/or the exothermic compound of heating element 515, can be in the form of a dry tablet or puck that could include different operation times (e.g., maximum duration of repellent dispersion or heating element operation) based on the degree to which the vent 525, 625 is opened (e.g., twisting the device 500, 600 partly opened, fully opened, etc.). In various examples, the first half 505, 605 and/or the second half 510, 610 can include at least one market, recess, or cavity configured to receive a dry puck (e.g., a heating element 515 or insect repellent element 530). In these examples, the pocket can receive one of a plurality of pucks, including non-insect repellent pucks (e.g., scented pucks) or otherwise. In other related embodiments, the first half 505, 605 and/or the second half 510, 610 can include more than one cavity 520, where each cavity 520 can receive an insect repellent puck 530 such that multiple pucks 530 are in use to provide an increased concentration of insect repellent compound.

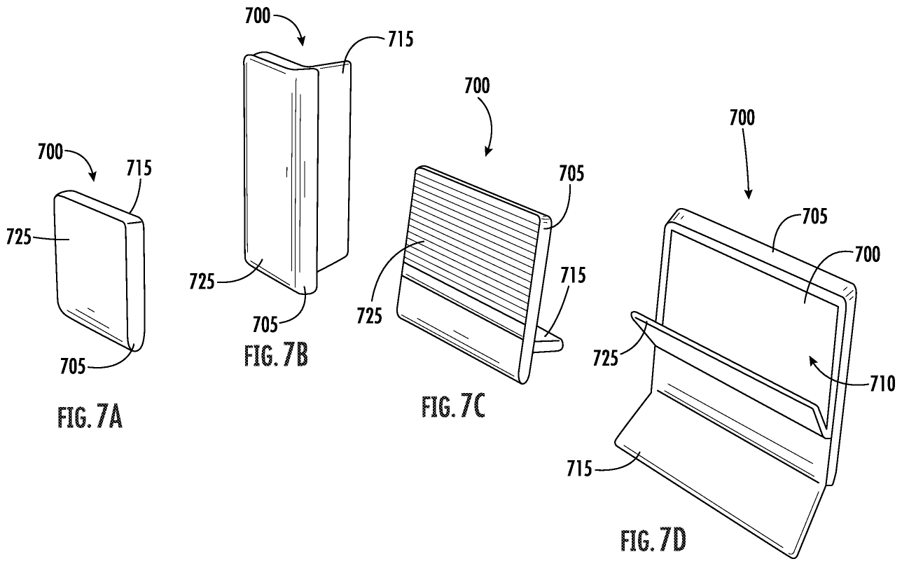

Referring now to FIG. 7, another non-powered insect repellent device 700 is shown. The device of FIG. 7 is shown in a book form factor, including a body 705 defining an interior cavity 710 and a lid 715 configured to pivot relative to the body 705 and cover the cavity 710. In one example, the lid 715 of the device prevents activation of a heating element 720 located within the interior cavity 710 of the body 705. Preventing activation of the heating element 720 can, in some examples, prolong an operational lifespan of the heating element 720. In one example embodiment, the chemical formulations of the device 700 would be contained behind vent/lattice structure 725 within the interior cavity 710. In some examples, the device 700 can stand in various positions on a flat surface to provide a decorative aspect. Specifically, the body 705 may be oriented longitudinally (e.g., vertically) on a table where the lid 715 acts as a stand to prevent the body 705 from tipping when the lid 715 is open. In some examples, the device 700 could be fabricated in different ways for particular use-case scenarios. According to some examples, the heating element 720 and/or an insect repellent element contained within the interior cavity 710 can be replaced with a new heating element 720 (e.g., a pouch containing an exothermic compound) or a new insect repellent (e.g., a dry puck or an absorbent pad saturated or semi-saturated with insect repellent liquid). In this way, the device 700 refillable. Decorative features on the device 700 can make the device 700 discreet, according to one example.

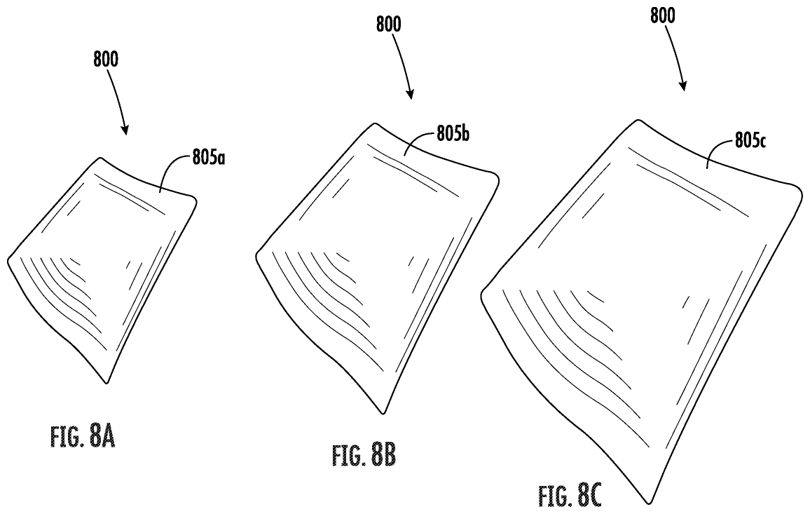

Referring now to FIG. 8, another non-powered insect repellent device 800 is shown. The device 800 of FIG. 8 can include a pouch 805 comprising a heating element and/or an insect repellent compound. In some examples, the pouch 805 can have varying sizes, such as a small pouch 805a, a medium pouch 805b, and a larger pouch 805c, where the larger pouch 805c can be associated with a longer operational life span (e.g., increased heating capacity or increased insect repellent concentration). In some examples, the pouch 805 is a single use application, similar to that of a hand or foot warmer. In this embodiment, the pouches 805a-805c could also be used as a means to refill other insect repellent devices (e.g., devices 100-700) with additional heating compound and/or insect repellent.

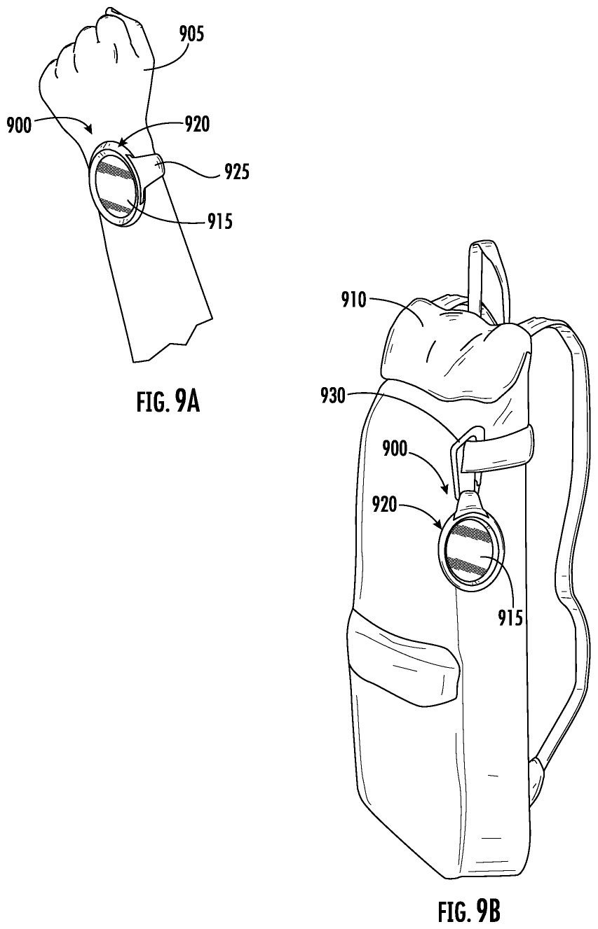

Referring to FIG. 9, a wearable non-powered insect repellent device 900 is shown. The device 900 of FIG. 9 can mimic a wristband application or a clip-on application for items such a daypacks for hikers. In these embodiments, the device 900 is used in a manner that allows for the user 905 to wear the device while moving. For example, the device 900 could be worn on a wrist or an ankle of a user 905. For example, the device 900 can include a strap or band 925 to fix the device 900 to an appendage of the user. In another example, the device 900 can be clipped to clothing, belts, backpacks (e.g., the backpack 910) and the like. For example, the device 900 can include a clip 930 (e.g., a carabiner, keychain, etc.). The device 900 can include at least one vent on a top portion 915 or member of a housing 920 of the device 900 that allows air to flow within a cavity of the device 900 and allowing an insect repellent to emanate from the device 900 while also substantially preventing a consumer from accessing the cavity of the device 900. In related examples, the device 900 could have an on/off function, such as a twist to activate and deactivate feature like that described above with reference to FIGS. 5-6. Various embodiments can be configured for different operational lifespans by including, for example, a higher volume of insect repellent or a larger heating element with increased heating capacity. In some examples, the vent of the device 900 can be opened to varying degrees such that a consumer can modify the volume of air that flows into the cavity, thereby facilitating control of the rate of heating energy generation and/or insect repellent dispersion. The heating element and/or insect repellent element of the device 900 shown in FIG. 9 can also be replaceable. In these examples, the outer housing 920 of the device may be reused.

In other aspects of the disclosed invention, the systems described herein could further comprise an indicator concept to show when in use, or show need to refill. Fragrance could be used in conjunction with these concepts to indicate usage as well as an added benefit. Heat activated color changing could be used with any of these as well to allow a visual cue for consumers to know when working/complete.

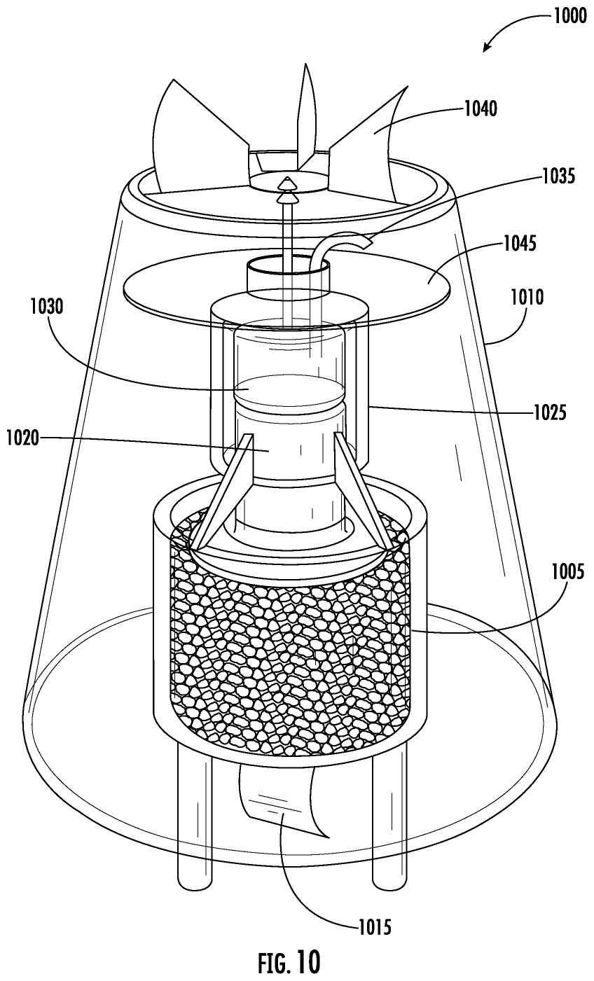

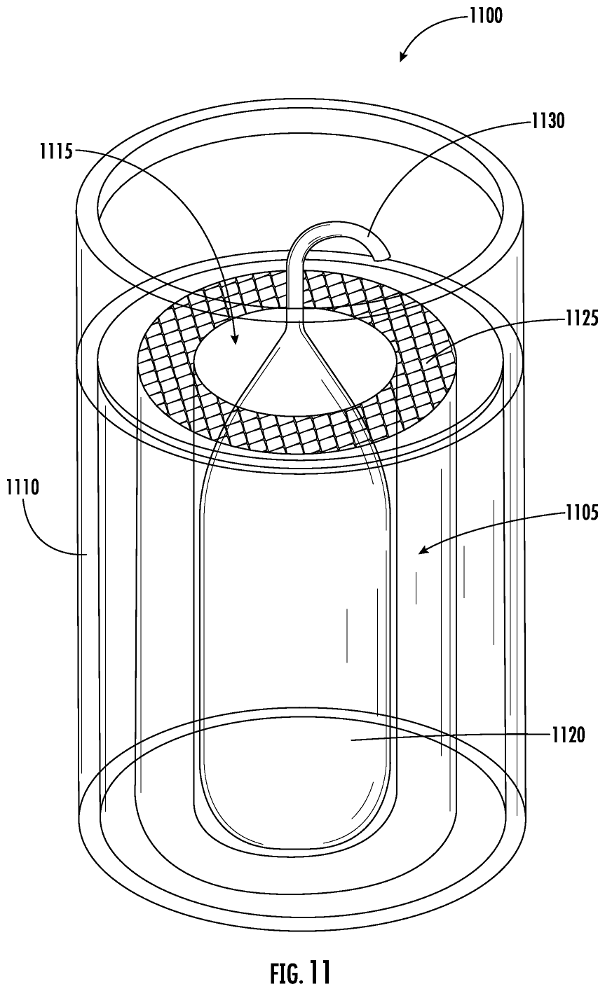

Referring now to FIGS. 10-11, a non-powered insect repellent device using an expanding heating element is shown. In various embodiments, such as those shown in FIGS. 10 and 11, the non-powered insect repellent device can include an expandable heating element. The heating element can include an exothermic compound that generates heat when exposed to air or oxygen. When activated (e.g., when an exothermic reaction within or associated with the heating element is occurring), the heating element can swell or expand in size. As the heating element expands, the heating element can exert a force on surrounding components of the non-powered insect repellent device. For example, the expanding heating element can exert a force on a moveable piston within a housing of the insect repellent device. The moveable piston can in turn exert a force on a bladder or syringe containing insect repellent liquid, which can cause the bladder or syringe to dispense insect repellent. In another example, the heating element could define an aperture or cavity, and a bladder or syringe could be disposed within the cavity. As the heating element expands, the cavity can shrink and a force can be imparted on the bladder or syringe, which can cause the bladder or syringe to dispense insect repellent. In other embodiments, the expanding heating element can exert a pushing force or squeezing force on other components that directly or indirectly cause insect repellent fluid to be dispensed. For example, the expanding heating element can squeeze an air-filled bladder, thereby generating pressure within a tube coupled with the bladder. The pressure within the tube can drive a piston, which dispenses insect repellent, for example.

The device 1000 of FIG. 10 can include a heating element 1005 positioned within a housing 1010. The heating element 1005 can comprise an exothermic compound, such as those described above, that generates heating energy via chemical reaction when exposed to oxygen or air. The heating element 1005 can include a removable tab 1015 that can be selectively removed from the heating element 1005 to expose the exothermic compound to air, thereby initiating an exothermic reaction to activate the heating element 1005. The device 1000 can also include a moveable piston 1020 positioned above the heating element 1005, the piston configured to slide within a chamber 1025. A bladder 1030 comprising a spout 1035 (e.g., nozzle, orifice, outlet, etc.) can be located within the chamber 1025 above the moveable piston 1020. As described above, the heating element 1005 can be configured to expand when activated. A bottom and sidewall of the heating element 1005 can be fixed or stationary to direct expansion of the heating element 1005 upwards. As the heating element 1005 expands, the heating element 1005 can exert a force on the moveable piston 1020 that causes the moveable piston to slide or translate within the chamber 1025. As the piston 1020 slides, the piston 1020 may exert a force on the bladder 1030. The bladder 1030 can include a volume of liquid (e.g., insect repellent, fragrant liquid, etc.). The force exerted by the piston 1020 on the bladder 1030 may cause a portion of the volume of liquid to be dispensed from the bladder 1030 via the spout 1035, according to one example. The liquid can be dispensed from the bladder 1030 on to an absorbent pad, a drip tray, a permeable tray, or another surface, according to one example.

In one example, the device 1000 can include a rotatable top cover, shown as fan 1040. The fan 1040 can rotate as air heated by the activated heating element 1005 rises through the housing 1010. According to one example, the liquid can be dispensed by via the spout 1035 onto a permeable drip tray 1045 that is rotatably coupled with the spin shade 1040. As the spin shade 1040 rotates, the insect repellent and any chemical vapors associated therewith can be dispensed into the air proximate the device 1000. When the heating element 1005 is consumed (e.g., the exothermic reaction of the exothermic compound is complete), the spin shade 1040 may stop rotating. In some examples, the heating element 1005 can be configured to have an operational lifespan that corresponds with a volume of liquid within the bladder 1030 and a rate of movement of the piston 1020 such that the heating element 1005 is consumed after approximately the same duration of time as the liquid is completely dispensed from the bladder 1030.

Referring now to FIG. 11, a non-powered insect repellent device 1100 is shown, according to one example. The device 1100 can include a heating element 1105 positioned within a housing 1110. The heating element 1105 can define a cavity or aperture 1115. According to one example, the heating element 1105 has a cylindrical shape with a cylindrical cavity formed completely or partially therethrough. For example, the heating element 1105 can have a hollow cylindrical or annular shape. The cavity 1115 can receive a bladder 1120 that can contain a volume of liquid (e.g., insect-repellent, fragrant liquid, etc.). The heating element 1105 can be configured to expand when activated. In other words, the heating element 1105 can include chemicals (e.g., exothermic compound) that generates heating energy when the exothermic compound are exposed to air or oxygen. As the exothermic compound is exposed to air and generates heat, the exothermic compound (and thus the heating element 1105) can expand in size (e.g., the volume of the heating element 1105 can increase). The heating element 1105 can expand in size, which can cause the cavity 1115 to correspondingly shrink in size. For example, an outer surface, top, or bottom of the heating element 1105 can be fixed or stationary to direct an expansion of the heating element 1105 into the cavity 1115. At least one wall 1125 can exert a force on the bladder 1120 as the cavity 1115 shrinks. A force exerted on the bladder 1120 can cause at least a portion of the liquid of the bladder 1120 to dispense via a spout 1130 in fluid communication with the bladder 1120. The liquid can be dispensed onto a heated, vaporizing surface. For example, the liquid can be dispensed onto a surface positioned above the heating element 1105 and warmed by the heating element 1105, where the temperature of the surface causes the liquid to vaporize or emanate into the air proximate to the device 1100. In some examples, the heating element 1105, the housing 1110, the bladder 1120, the liquid within the bladder 1120, and/or the surface onto which the liquid is dispensed can include thermochromatic ink that changes color when heated to provide a visual indication to a consumer that the device 1100 is active.

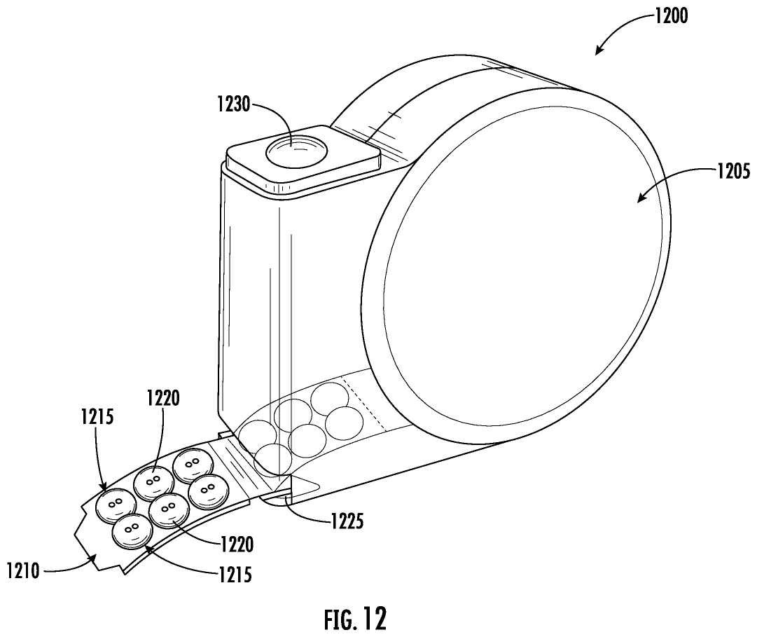

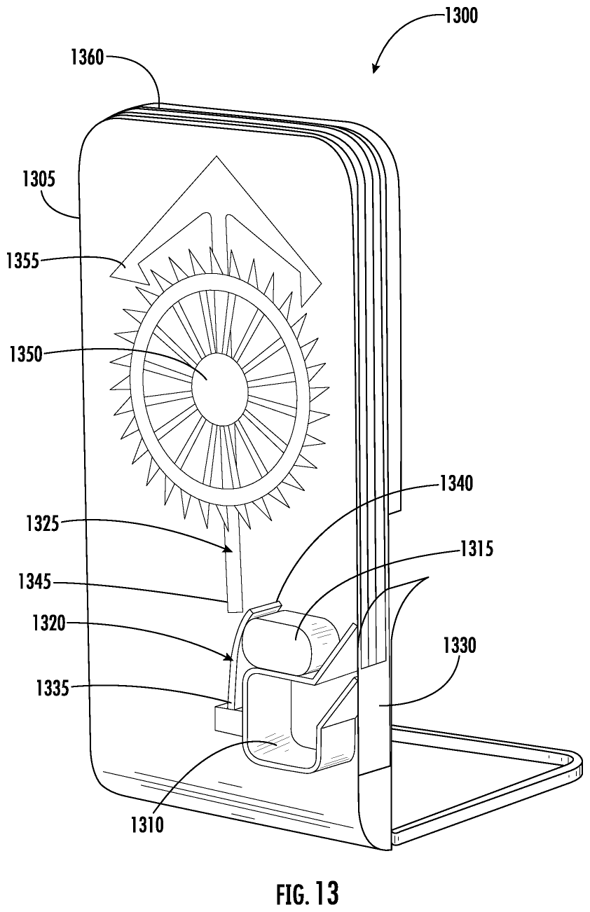

Referring now to FIGS. 12-13, a non-powered insect repellent device using multiple heating elements corresponding to multiple insect repellent elements. In other examples, the device can include a single heating element and a single insect repellent element. Each heating element can include chemicals (e.g., an exothermic compound) that, when exposed to air or oxygen, cause the heating element to generate heating energy. The heating energy produced by the heating element can further cause the insect repellent element to dispense or disperse an insect repellent chemical. According to an exemplary embodiment, the non-powered insect repellent device can be configured to operate in a metered fashion such that the heating element(s) and the insect repellent element(s) are consumed over a period of time at a desired rate. In examples including multiple heating elements, at least one of the heating elements can be activated separately from other heating elements. Accordingly, the non-powered insect repellent devices can be configured for multiple uses spanning different times, where at least one heating element and insect repellent element are used for one use, and at least another heating element and insect repellent element are used for a second use. Furthermore, to increase a rate of insect repellent dispersion (e.g., to increase a concentration of insect repellent that is dispersed), multiple of the plurality of heating elements can be activated simultaneously. In examples where the non-powered insect repellent device includes a single heating element, the device can be configured to consume only a portion of the heating element and insect repellent element at a given time. For example, the device can be configured to alternate between an “on” state where the heating element generates heating energy and an “off” state where the heating element does not generate heating energy. The device can be configured to alternate between the “on” and “off” state at a predefined rate (e.g., 1 minute cycles, 2 minute cycles, 15 minute cycles, etc.).

Referring now to FIG. 12, a non-powered insect repellent system 1200 is shown. The device 1200 can include a housing 1205 and a dispensable insect repellent substrate 1210. In one example, the dispensable insect repellent substrate 1210 can include a plurality of insect repellent devices 1215. Each insect repellent device 1215 can include a heating element and an insect repellent element 1220. In one example, the heating element can include an exothermic compound that is configured to generate heating energy when exposed to oxygen. The insect repellent element 1220 can be a wick ring or absorbent pad that is saturated or semi-saturated with an insect repellent chemical solution. The insect repellent substrate 1210 can be a rolled “tape” of insect repellent devices 1215, where the rolled insect repellent substrate 1210 can be housed within the housing 1205 and dispensed from a dispensing end 1225 of the device 1200. One or more insect repellent devices 1215 can be dispensed from the dispensing end 1225 at a time, according to one example. In another example, the housing 1205 can include a button 1230 that, when depressed, causes one or more pins (e.g., needle, point, tack, etc.) to pierce a foil coupled to the insect repellent device 1215. As noted above, the pierced foil can allow oxygen to reach the heating element to activate an exothermic reaction and can further allow an insect repellent chemical solution to emanate from the insect repellent element 1220. The button 1230 can further cause the rolled insect repellent substrate 1210 to advance, thereby dispensing at least one insect repellent device 1215. In another example, the button 1230 can cause a blade or trimming bar to cut or shear the insect repellent substrate 1210 to separate an insect repellent device 1215 from the insect repellent substrate 1210. The heating element and the insect repellent element 1220 can be configured to have a similar operational lifespan such that the insect repellent element 1220 is fully consumed proximate to a time when the heating element is fully consumed.

In some examples, the insect repellent substrate 1210 can include an adhesive element and a removable non-adhesive layer coupled with the adhesive element. For example, each insect repellent device 1215 can be coupled with an adhesive element. One or more insect repellent devices 1215 can be separated from the insect repellent substrate 1210 via the blade or trimming bar actuated by the button 1230. Each of the separated insect repellent devices 1215 can be activated (e.g., am exothermic reaction of the heating element can cause insect repellent chemical solution to emanate from the device 1215). The removable non-adhesive layer can be removed from the adhesive element to expose the adhesive element. The adhesive element of an insect repellent device 1215 separated from the insect repellent substrate 1210 can be affixed to an article of clothing, a table, a bicycle, a lawn chair, or other surface.

In other examples, the insect repellent element 1220 can be positioned above the heating element such that heat generated by the heating element can cause the insect repellent chemical solution to vaporize or emanate from the insect repellent element 1220. For example, a foil or pierce-able cover can be coupled with the insect repellent device 1215. When the foil is pierced, oxygen or air can flow to the heating element, causing the heating element to activate and generate heating energy. Further, the foil can be pierced to allow the insect repellent chemical solution to emanate from the insect repellent device 1215. In one example, the foil can be disposed between the heating element and the insect repellent element 1220, where the pierced foil activates the heating element but does not allow insect repellent chemical solution vapors to emanate from the device 1215. The insect repellent element 1220 can include a thin (e.g., plastic, wax paper, etc.) cover that can be pierced to allow insect repellent chemical solution to emanate to the surrounding environment.

Referring now to FIG. 13, a non-powered insect repellent device 1300 is shown. The insect repellent device 1300 can include a housing 1305, a heating element 1310, a thermal conductor 1315, a bimetallic member 1320, a screw-syringe dispenser 1325, and a removable cover 1330. The heating element 1310 can include an exothermic compound that is configured to generate heating energy when exposed to air. The heating element 1310 can be thermally coupled with the thermal conductor 1315 such that the thermal conductor 1315 conducts thermal energy (e.g., heating energy) when the heating element 1310 is active (e.g., generating heating energy). According to one example, the heating element 1310 can be exposed to oxygen or air when the removable cover 1330 is at least partially removed from the housing 1305. Air can flow through the housing 1305 (e.g., from a bottom proximate the heating element 1310 to a top) with the removable cover 1330 at least partially removed or peeled.

The bimetallic member 1320 can be positioned proximate to the thermal conductor 1315 and can include a fixed end 1335 and a free end 1340. In one example, the free end of the bimetallic member 1320 can contact a free end 1345 of the screw-syringe dispenser 1325. The bimetallic member 1320 can be configured to change position (e.g., change from flexing in a first direction to flexing in a second direction) based on the temperature of the bimetallic member 1320. For example, the free end 1340 of the bimetallic member 1320 can move (e.g., snap, flip, switch) from a first position proximate the thermal conductor 1315 to a second position spaced apart from the thermal conductor 1315 in response to a change in temperature resulting from heat emanated by the thermal conductor 1315. In particular, the free end 1340 of the bimetallic member 1320 can snap from the first position to the second position when the temperature of the bimetallic member 1320 reaches a certain threshold temperature, according to one example. Moreover, the free end 1340 of the bimetallic member 1320 can be configured to cool (e.g., reduce in temperature) when the free end 1340 is in the second position spaced apart from the thermal conductor 1315. In one example, the free end 1340 of the bimetallic member 1320 can be configure to move (e.g., snap, flip, switch) from the second position to the first position when a temperature of the free end 1340 decreases below a certain threshold temperature.

As the free end 1340 of the bimetallic member 1320 moves between the first position and the second position, the free end 1345 of the screw-syringe dispenser 1325 can move from a first position to a second position and vice versa. The screw-syringe dispenser 1325 can be configured to pivot about a center point 1350. Further, the screw-syringe dispenser 1325 can include a pacing mechanism 1355 (e.g., a ratchet or gear mechanism coupled with the free end 1345 and the center point 1350). In one example, the movement of the free end 1345 from the first position to the second position and vice versa can cause the pacing mechanism 1355 to advance in a first direction (e.g., the ratchet or gear mechanism can be a one-way rotating device that rotates only in a first direction). As the pacing mechanism 1355 advances, a metered volume of insect repellent liquid can be dispensed from an insect repellent liquid reservoir. The insect repellent liquid can be dispensed from the screw-syringe dispenser 1325, according to one example. In other examples, the insect repellent liquid can be dispensed in a predetermined portion (e.g., volume, amount) as the bimetallic member 1320 moves from the first positon to the second position and vice versa. In one example, the insect repellent liquid can be vaporized and can flow through a top 1360 of the housing. The device 1300 can also include a thermochromatic portion that changes color when the heating element 1310 is active. In another example, the device 1300 can include a visual indicator corresponding to the pacing mechanism to show the screw-syringe dispenser 1325 advancing.

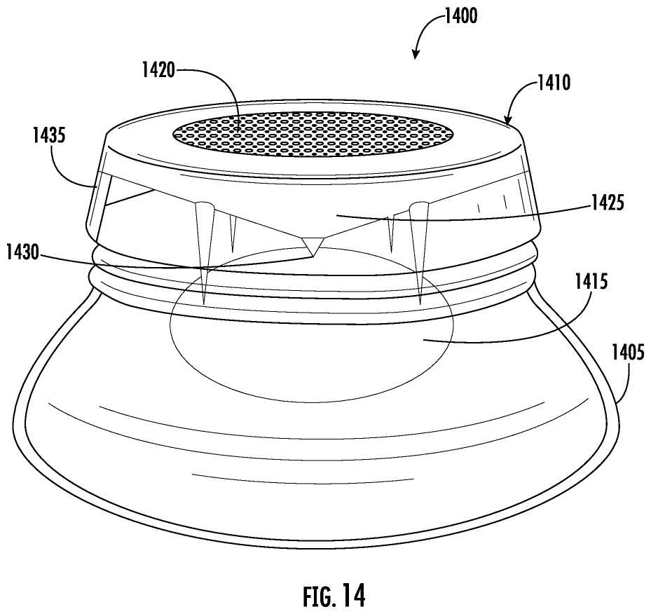

Referring now to FIG. 14, a non-powered insect repellent device 1400 is shown. The device 1400 can include a first housing 1405 and a second housing 1410. In various examples, the second housing 1410 can be rotatably coupled with the first housing 1405. The first housing 1405 and the second housing 1410 can collectively define an interior cavity. A heating element can be positioned within the interior cavity and can be configured to generate heating energy when an exothermic compound of the heating element is exposed to air or oxygen. The heating element can be thermally coupled with a bladder, reservoir, or vial 1415. The bladder, reservoir, or vial 1415 can include a volume of insect repellent liquid, according to one example. In some examples, heating energy generated by the heating element can cause the insect repellent liquid to vaporize and/or emanate into the air.

The second housing 1410 can define at least one aperture 1420 (e.g., vent hole, perforation, slot, opening, etc.) that are configured to allow air to flow into a cavity 1425 of the second housing 1410. The second housing 1410 can also include at least one point 1430 (e.g., pin, needle, stake, etc.) that is configured to pierce a cover or foil. The point 1430 can be configured to pierce a bladder, reservoir, or vial 1415 or a cover of a bladder, reservoir or vial 1415. In one example, the point 1430 can be configured to draw or wick an insect repellent chemical solution from the vial 1415 via an opening defined by the point 1430. The insect repellent chemical solution can then be vaporized or emanate through the aperture 1420 and emanate into the air surrounding the device 1400. In another example, another point 1430 can be configured to pierce a foil layer coupled with the heating element. The heating element can be exposed to oxygen via an aperture (e.g., hole, opening) in the pierced cover or foil, thereby initiating an exothermic reaction to generate heating energy.

The second housing 1410 can include a control ring element 1435. The control ring element 1435 can be configured to rotate with respect to the first housing 1405. In one example, the second housing 1410 can be positioned on top of (e.g., above, coupled with a top portion, etc.) of the first housing 1405. The control ring 1435 can be threaded to the first housing 1405 such that rotation of the control ring 1435 causes the second housing 1410 to move vertically with respect to the first housing 1405. For example, as the control ring 1435 rotates in a first direction, the second housing 1410 can move downwards with respect to the first housing 1405 to cause the point 1430 (or a plurality of points 1430) to pierce a foil covering the heating element and/or a foil covering the vial 1415 of insect repellent chemical solution. The control ring 1435 can be rotated in a second direction to cause the second housing 1410 to move upwards from the first housing 1405. In various examples, the control ring 1435 can be configured to rotate between a plurality of predefined positions. In a first position, the control ring 1435 can cause the point 1430 to pierce the vial 1415 and/or a foil covering the heating element. In a second position, the control ring 1435 can allow air to flow into the interior cavity to initiate and continue an exothermic reaction and cause insect repellent to be dispensed. In a third position, the control ring 1435 may prevent oxygen or air from entering the interior cavity in order to stop the exothermic reaction and/or stop the point 1430 from wicking insect repellent chemical solution. In a fourth position, the control ring 1435 can be configured to allow the second housing 1410 to be removed from the first housing 1405 (e.g., so that the insect repellent solution within the vial 1415 can be replenished or to replace the heater element). In some examples, the rotation of the control ring 1435 can cause an activant material to contact the heating element to initiate an exothermic reaction. For example, rather than being activated by air, the heating element can be activated by some other material (e.g., water, glycerol, or some other substance). At least one point 1430 can pierce a bladder containing activant substance as the control ring 1435 is rotated. With the bladder pierced, the activant substance may contact (e.g., mix with, touch, saturate, etc.) a thermal material of the heating element to cause the exothermic reaction. Accordingly, the non-powered insect repellent device 1400, among other embodiments described herein, can include a heating element activated by some substance other than air to create an exothermic reaction which can in turn cause an insect repellent solution to emanate from the device 1400.

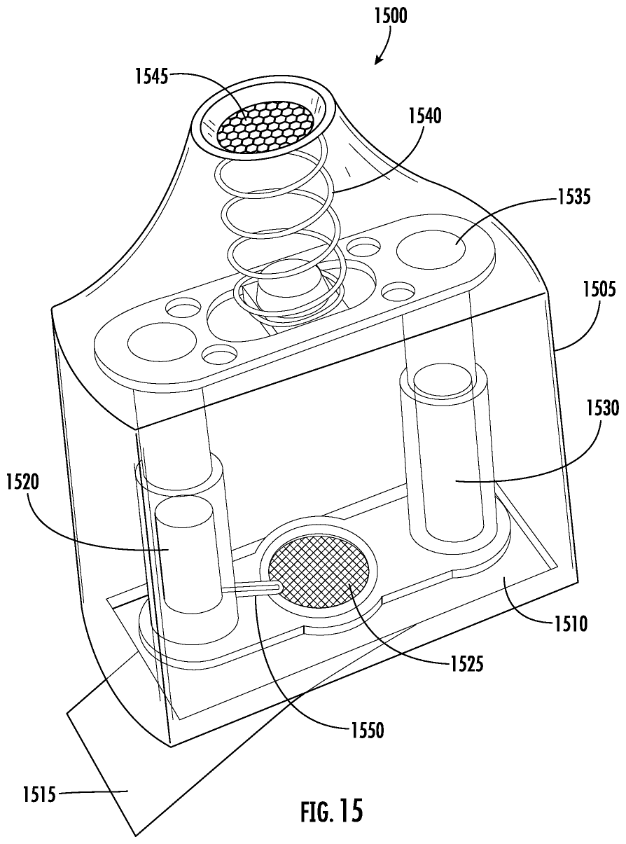

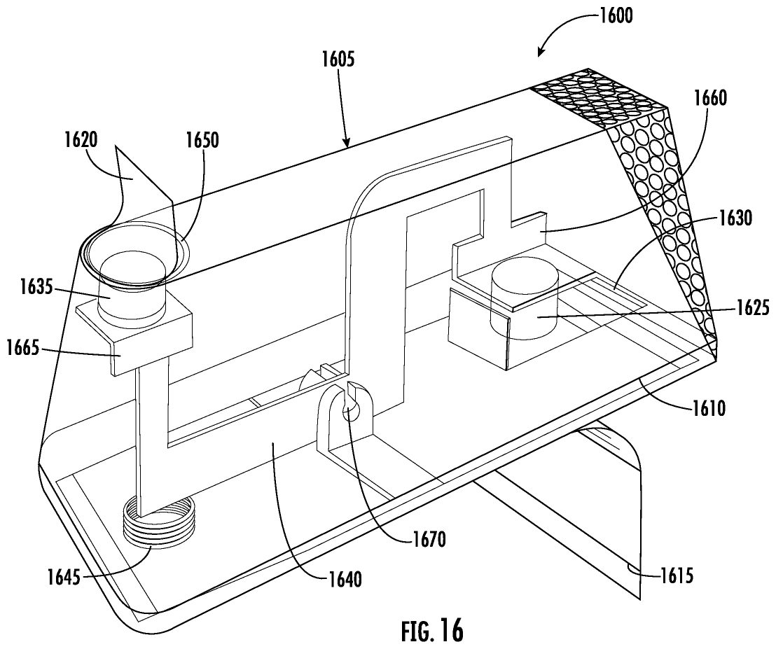

Referring now to FIGS. 15-16, a non-powered insect repellent device is shown to include an insect repellent material. The non-powered insect repellent device can include a heater element comprising an exothermic compound that is configured to generate heating energy when exposed to air or oxygen. The device can also include a chamber containing a volume of insect repellent liquid. The chamber can be in fluid communication with a dispenser (e.g., a tube, nozzle, orifice, etc.). The device can also include a surface configured to capture dispensed insect repellent liquid. In one example, the surface can be thermally coupled with the heating element or can be configured to increase in temperature as the heating element generates heating energy. The device can include a heater-activated material and a piston (e.g., mover, lever, arm, etc.) that is couple with the heater-activated material and the chamber. The heater-activated material can be configured to change form, shape, size, etc. in response to heating energy. For example, the heater-activated material can be configured to shrink as it is heated. According to one example, as the heater-activated material changes form, it causes a piston to move to cause insect repellent liquid to be dispensed onto the surface, where it can be vaporized and emanated into the air surrounding the device.

Referring now to FIG. 15, a non-powered insect repellent device 1500 is shown. The device 1500 can include a housing 1505, a heater element 1510, a removable cover 1515, a chamber 1520, a surface 1525, a heater-activated material 1530, a lever mechanism 1535, and a spring 1540. The housing 1505 can include a vent 1545 configured to allow heated air to escape a cavity defined by the housing 1505. The heater element 1510 can include an exothermic chemical compound that is configured to generate heating energy when exposed to oxygen or air. In one example, the removable cover 1515 can be removed from a base of the housing 1505 to allow air or oxygen to be exposed to the heater element 1510. The chamber 1520 can include a volume of insect repellent liquid. The chamber 1520 can be fluidly coupled to a dispenser 1550 and can be configured to dispense insect repellent liquid through the dispenser 1550 in response to a force exerted on the chamber 1520. The dispenser 1550 can dispense a metered portion of insect repellent material onto the surface 1525. The surface 1525 can be thermally coupled with or can be heated by the heater element 1510 when activated.

The heater-activated material 1530 can comprise a wax material, a gel material, or some other material that is configured to at least partially change form (e.g., shape, size, etc.) in response to heating energy (e.g., heating energy generated by the heating element 1510). In one example, the heater-activated material 1530 can be a wax material that is configured to melt or liquefy when heated. The lever mechanism 1535 can be coupled with the chamber 1520 and the heater-activated material 1530. The lever mechanism 1535 can be further coupled with the spring 1540 such that the spring exerts a force on the lever mechanism 1535 to push the lever mechanism 1535 towards the chamber 1520 and the heater-activated material 1530. The lever mechanism 1535 can thus act as a piston to apply a force towards the chamber 1520 and the heater-activated material 1530. The size, shape, and position of the heater-activated material 1530 can limit (e.g., stop or prevent) the movement of the lever mechanism 1535. Accordingly, as the heater-activated element 1530 changes shape, form, size, etc., the piston mechanism 1535 can translate or move in response to the force applied by the spring 1540. A portion (e.g., volume, amount, etc.) of the insect repellent liquid can be dispensed from the chamber 1520 via the dispenser 1550 based on the movement of the lever mechanism 1535 as the heater-activated material 1530 changes shape, size, form etc. The portion of insect repellent liquid can be vaporized on the surface 1525 by the heating energy within the housing 1505, according to one example.

Referring now to FIG. 16, a non-powered insect repellent device 1600 is shown. The device 1600 can include a housing 1605, a heater element 1610, a first removable cover 1615, a second removable cover 1620, an insect repellent element 1625, a surface 1630, a heat-activated element 1635, a lever mechanism 1640, and a spring 1645. The housing 1605 can include a vent 1650 configured to allow heated air to escape a cavity defined by the housing 1605. The heater element 1610 can include an exothermic chemical compound that is configured to generate heating energy when exposed to oxygen or air. In one example, the first removable cover 1615 can be removed from a base of the housing 1605 to allow air or oxygen to be exposed to the heater element 1610. In another example, the second removable cover 1620 can be removed to expose the heater element 1610 to oxygen and/or to allow air to vent through an opening in the housing 1605 and past the heat-activated element 1635. Air flowing past the heat-activated element 1635 can facilitate the drying out of the heat-activated element 1635, thereby causing it to change form, according to one example. The insect repellent element 1625 can include a volume of insect repellent liquid. The insect repellent element 1625 can be fluidly coupled to a dispenser and can be configured to dispense insect repellent liquid through the dispenser in response to a force exerted on the insect repellent element 1625. The dispenser can dispense a metered portion of insect repellent material onto the surface 1630, according to one example. The surface 1630 can be thermally coupled with or can be heated by the heater element 1610 when activated.

The heat-activated element 1635 can comprise a wax material, a gel material, or some other material that is configured to at least partially change form (e.g., shape, size, etc.) in response to heating energy (e.g., heating energy generated by the heater element 1610). In one example, the heat-activated element 1635 can be a gel material that is configured to dry, shrink, and/or solidify when heated. The lever mechanism 1640 can include a first end 1660 and a second end 1665. The first end 1660 of the lever mechanism 1640 can be coupled with the insect repellent element 1625 and can move in a first direction. The second end 1665 of the piston mechanism can be coupled with the heat-activated element 1635 and can move in a second direction. In some examples, the lever mechanism 1640 can rotate about a pivot point 1670, where rotation about the pivot point 1670 causes the first end 1660 to move in the first direction and the second end 1665 to move in the second direction. The lever mechanism 1640 can be further coupled with the spring 1645 such that the spring exerts a force on the lever mechanism 1640 to push the lever mechanism 1640 towards the insect repellent element 1625 and the heat-activated element 1635. The lever mechanism 1640 can thus act as a piston to apply a force towards the insect repellent element 1625 and the heater-activated element 1635. The size, shape, and position of the heat-activated element 1635 can limit (e.g., stop or prevent) the movement of the lever mechanism 1640. Accordingly, as the heat-activated element 1635 changes shape, form, size, etc., the lever mechanism 1640 can translate or move in response to the force applied by the spring 1645. A portion (e.g., volume, amount, etc.) of the insect repellent liquid can be dispensed from the insect repellent element 1625 via the dispenser based on the movement of the first end 1660 of the lever mechanism 1640 as the heat-activated element 1635 changes shape, size, form etc., thereby permitting the second end 1665 of the lever mechanism 1640 to move in the second direction. The portion of insect repellent liquid can be vaporized on the surface 1630 by the heating energy within the housing 1605, according to one example.

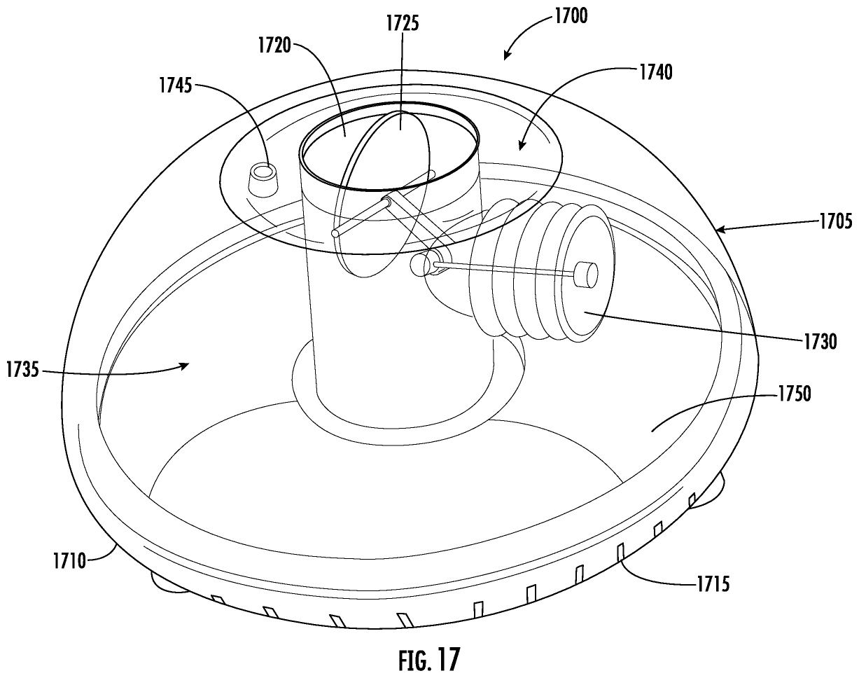

Referring to FIGS. 17-19, a non-powered insect repellent device is shown. The device can include a heater element including an exothermic chemical compound configured to generate heating energy when exposed to oxygen and an insect repellent element including an insect repellent chemical solution. The device can also include a heat regulating device that selectively limits or prevents air (e.g., air) from flowing to the heating element, thereby limiting the generation of heating energy by the heating element. The heat regulating element can operate to selectively starve the heating element of oxygen, which can slow or stop the exothermic reaction of the heating element. For example, the heat regulating element can be a pressure-regulated bellows that selectively closes when a pressure inside of a chamber reaches a threshold pressure. In another example, the heat regulating element can be a bimetallic member that selectively moves from a first position (e.g., a bent position) to a second position (e.g., a straightened position) when a temperature of the bimetallic member surpasses a threshold temperature. In another example, the heat regulating device can include a plurality of arms, where a movement of one arm (e.g., a paddle, cover, etc.) can cause a movement of another arm. More specifically, one arm could be configured to move in a first direction (e.g., lift upwards) as pressure in a first chamber increases (e.g., as the first chamber expands or swells in response to an increased internal pressure), which can corresponding cause another arm to close on an opening (e.g., aperture, vent, slot, orifice) to starve a second chamber of oxygen. Relatedly, as pressure in the first chamber decreases, the first arm can move in a second direction (e.g., fall downwards), which can cause the second arm to open the opening to allow oxygen to flow into the second chamber.

Referring now to FIG. 17, a non-powered insect repellent device 1700 is shown. The device 1700 can include a cover 1705 and a base 1710 having at least one vent 1715 (e.g., slots, opening, orifices, apertures, etc.) configured to allow air to flow into the base 1710 when in an open position. The cover 1705 can define an interior cavity 1735. The cover 1705 can define a central column 1720. The central column 1720 can include a damper 1720 that rotates about an axis to selectively open or close the central column 1720. Air can flow from the base 1710 through the central column 1720 with the damper 1725 in a first position. The damper 1725 can prevent air from flowing through the central column 1720 with the damper 1725 in a second position, according to one example. The device 1700 can include a bellows 1730 that actuates the damper 1725 in response to an increase in pressure within the interior cavity 1735. The bellows 1730 can include a spring constant such that a spring force is acting to expand the bellows 1730 is generated as the bellows 1730 is compressed. For example, when the bellows 1730 is under pressure within the interior cavity 1735, the bellows 1730 compressed and the bellows 1730 can actuate the damper 1725 to close the central column 1720. Relatedly, when pressure within the interior cavity 1735 decreases, the spring force of the bellows 1730 will cause the bellows 1730 to decompress or expand, thereby opening the damper 1725. The device 1700 can also include a separate spring (not shown) that can cause the bellows 1730 to expand as pressure decreases. The device 1700 can include a top member 1740 that can be separate from or integral with the cover 1705. The top member 1740 can define an orifice 1745 that allows air to flow from the interior cavity 1735 while also causing pressure within the interior cavity 1735 to build (e.g., increase) in response to heat. In one example, the bellows 1730 can operate in response to a pressure of the interior cavity 1735.

The device 1700 can include a heating element comprising an exothermic chemical compound that can generate heating energy when exposed to air or oxygen. According to one example, the heating element can be positioned within or proximate to the base 1710 such that air flowing through the vent 1715 can activate the heating element (e.g., initiate an exothermic reaction to cause the heating element to generate heating energy). In one example, a removable cover can be removed from the base 1710 of the device 1700 to initiate the exothermic reaction. In another example, the base 1710 may be rotated relative to the cover 1705 to open the vent 1715, thereby allowing air to flow into the base 1710 to initiate the exothermic reaction. The device 1700 can also include an insect repellent chemical 1750 positioned within the interior cavity 1735. The insect repellent chemical 1750 can be positioned above or proximate to the heating element, according to one example. When heated, the insect repellent chemical 1750 vaporize when heated by the heating element. In some examples, the insect repellent chemical 1750 can be a fluid contained within a bladder that expands when heated, causing the bladder to open (e.g., burst, crack, fracture, etc.). A pressure within the interior cavity 1735 can increase as the interior cavity (and insect repellent chemical 1750) is heated by the heating element. Insect repellent chemical vapor can emanate through the orifice 1745 to the air surrounding the device 1700. As the pressure within the interior cavity 1735 builds, the bellows 1730 can actuate the damper 1725 to close the central column 1720. With the central column 1720 closed, air flow to the heating element can be reduced, thereby slowing the exothermic reaction, according to an example. As the rate of the exothermic reaction slows, the pressure within the interior cavity 1735 can reduce. As the pressure reduces, the bellows 1730 can actuate the damper 1725 to open the central column 1715 and increase air flow to the heating element. The damper 1725 can open and close in this cycle until the heating element and/or the insect repellent chemical 1750 is fully consumed. In some examples, the damper can stop actuating (e.g., moving between the open and closed positions) when the heating element and/or insect repellent chemical 1750 is fully consumed, providing a visual indication to a consumer that the device 1700 has reached the end of its operational lifespan.

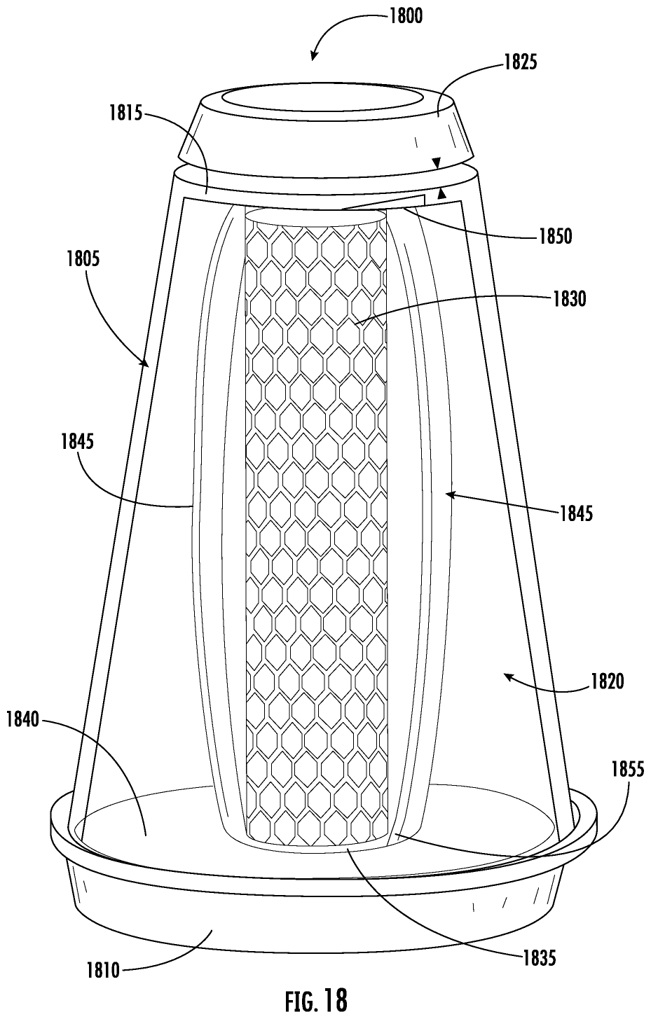

Referring now to FIG. 18, a non-powered insect repellent device 1800 is shown. The device 1800 can include a housing 1805 including a base 1810 and a cover 1815. One or more of the base 1810 and the cover 1815 can define an aperture (e.g., opening, hole, space, gap, etc.). The housing 1805 can define an interior cavity 1820. The device 1800 can include a cap 1825 rotatably coupled to the housing 1805. In one example, the cap 1825 can rotate between an open (e.g., unlocked) position and a closed (e.g., locked) position, where the cap 1825 can be spaced apart from the cover 1815 of the housing 1805 when in the open position, thereby permitting air to flow out of the cavity 1820 between the cap 1825 and the cover 1815. In one example, air is permitted to flow through the base 1810 and through the cover 1815 of the housing 1805 when the cap 1825 is in the open position. In some examples, air is not permitted to flow through the base 1810 and/or through the cover 1815 of the housing 1805 when the cap 1825 is in the closed position. The cap 1825 can be coupled with a heating element 1830 that extends at least partially through the cavity 1820 via an aperture defined by the cover 1815 of the housing 1805. The heating element 1830 can be coupled with a bottom member 1835. In some examples, the heating element 1830 can be a cylindrical heating element that extends through an aperture defined by the cover 1815 and an aperture defined by the base 1810 such that the heating element 1830 extends substantially through the entire cavity 1820. The heating element 1830 can include a chemical compound configured to generate heat via an exothermic reaction when exposed to air or oxygen. In some examples, the heating element 1830 is not exposed to oxygen or air when the cap is in the closed position. In various examples, the housing 1805, the cap 1825, or other components can include thermochromatic ink or other color-changing material to indicate that the device is operational (i.e., generating heat).

The device 1800 can include an insect repellent chemical 1840 positioned within the cavity 1820 and proximate to the heating element 1830. When heated, insect repellent chemical 1840 can vaporize and/or emanate from the cavity 1820 through an opening between the cap 1825 and the cover 1815 of the device 1800. The device 1800 can further include at least one bimetallic member 1845 that includes a first end 1850 and a second end 1855. The first end 1850 of the bimetallic member 1845 can be coupled with the cover 1815 of the housing 1805. The second end 1855 of the bimetallic member 1845 can be coupled with the base 1810 of the housing 1805. In various examples, the bimetallic member 1845 can flex, bend, or straighten as a temperature of the bimetallic member 1845 changes. According to one example, the bimetallic member 1845 can be in a flexed (e.g., bent, curved, arced, nonlinear, etc.) positon before the device 1800 is activated and/or before the heating element 1830 has increased the temperature of the bimetallic member 1845 above a threshold temperature. The bimetallic member 1845 can be configured to straighten if the temperature of the bimetallic member 1845 exceeds a threshold temperature. With the bimetallic member 1845 in a straightened orientation, the bimetallic member 1845 can lift the heating element 1830, bottom member 1835, and/or the cap 1825 of the device 1800 relative to the housing 1805. Put another way, when orientated in vertical (e.g., substantially vertical, partially vertical, etc.) orientation, the bimetallic member 1845 can cause at least one of the bottom member 1835, heating element 1830, and cap 1825 to translate in a vertical direction relative to the housing 1805.

In one example, the bimetallic member 1845 causes the bottom member 1835 to translate into a closed position relative to the base 1810 of the housing 1805. The bottom member 1835 can include a flange, seal, protrusion, ring, etc. that can contact (e.g., seat against, touch, seal against, etc.) the base 1810 in the closed position. When in the closed position, the bottom member 1835 can prevent air from flowing into the cavity 1820 via an aperture in the base 1810, thereby limiting or preventing air from flowing into the cavity 1820 to reduce or substantially stop an exothermic reaction of the heating element 1830 within the cavity 1820. As the exothermic reaction stops or slows, the bimetallic member 1845 may change from a straightened position to a curved (e.g., bent, flexed, etc.) position, thereby causing at least the bottom member 1835 to translate to an open position relative to the base 1810. When in the open position, the bottom member 1835 can be configured to allow air to flow into the cavity 1820, thereby providing oxygen for an exothermic reaction of the heating element 1830.

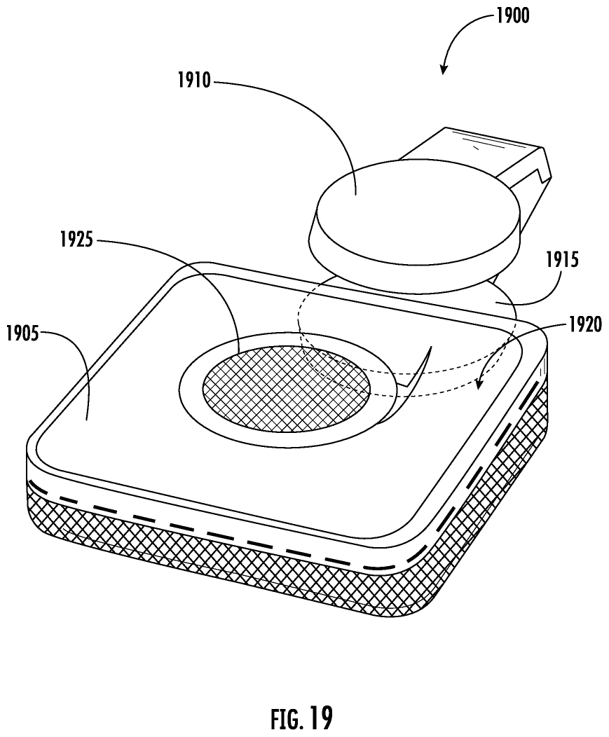

Referring now to FIG. 19, a non-powered insect repellent device 1900 is shown. The device 1900 can include a heating element, an insect repellent element 1905, a first paddle 1910, and a second paddle 1915. The heating element can include a chemical compound configured to generate heat via an exothermic reaction when exposed to air or oxygen, according to one example. The insect repellent element 1905 can be positioned proximate (e.g., on top of, adjacent to, etc.) the heating element and can be configured to emanate insect repellent vapor when heated. The first paddle 1910 and the second paddle 1915 can be operationally coupled such that movement of the first paddle 1910 can cause a movement of the second paddle 1915, and vice versa. The first paddle 1910 can be positioned over a first side 1920 of the device 1900 and the second paddle 1915 can be positioned over a second side of the device 1900. In one example, the insect repellent element 1905 can be positioned on the first side 1920, while the heating element can be positioned on the second side. The insect repellent element 1905 can emanate vapor through a first opening 1925 (e.g. orifice, aperture, vent, slot, gap, etc.) on the first side 1920. The first paddle 1910 can configured to selectively cover the first opening 1925, according to one example. The heating element can receive oxygen from an opening (e.g., orifice, aperture, vent, slot, gap, etc.) on the second side. The second paddle 1915 can be configured to selectively cover the second opening, according to one example. In some examples, the heating element and the insect repellent element 1905 can include a removable cover (e.g., foil, sticker, seal, etc.) that can be removed to allow air to flow to the heating element and vapor to emanate from the insect repellent element 1905.

In one example, the first paddle 1910 is configured to cover the first opening 1925 while the second paddle 1915 allows air to flow through the second opening. Furthermore, the first paddle 1910 is configured to allow vapor to flow from the first opening while the second paddle 1915 covers the second opening to prevent air from flowing therethrough. With the second paddle 1915 spaced apart from the second opening, air can flow to the heating element to facilitate an exothermic reaction to generate heating energy. The insect repellent element 1905 can warm as the heating element generates heating energy. The insect repellent element 1905 can be configured to increase in pressure and vaporize in response to the heating energy. The increased pressure from vapors can cause the first paddle 1910 to lift off of the first opening 1925 to allow vapors to escape the first side 1920. As the first paddle 1910 lifts, the second paddle 1915 can partially or completely close over the second opening to cause the exothermic reaction to slow or substantially stop, which correspondingly reduces the heating energy produced by the heating element. Reduced heating energy can cause the insect repellent element 1905 to cool, thereby decreasing the vaporization process and correspondingly reducing the vapor emanated through the first opening 1925. As the vapor pressure decreases, the first paddle 1910 can fall to cover the first opening 1925, which can cause the second paddle 1915 to lift form the second opening. An exothermic reaction of the heating element can increase as air is allowed to flow to the heating element again. This cycle can repeat until the heating element and/or the insect repellent element 1905 is consumed.

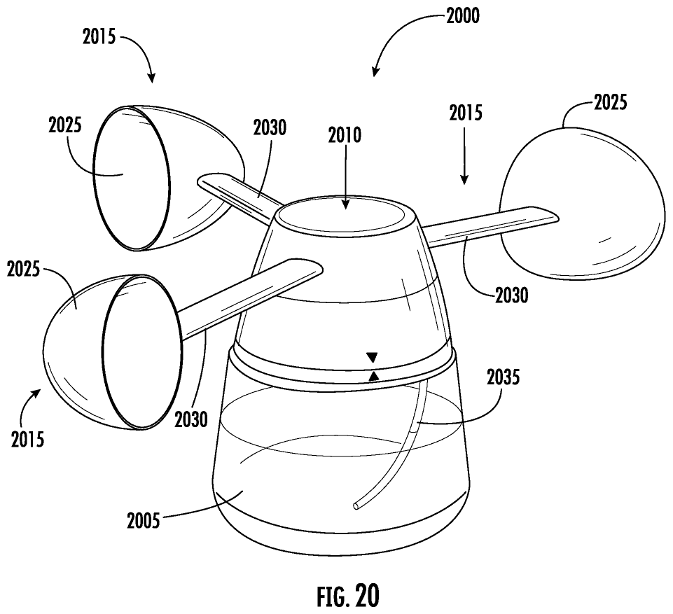

Referring now to FIG. 20, a non-powered insect repellent device 2000 is shown. The device 2000 can include a vial 2005, a cover 2010, and at least one blade 2015. The vial 2005 can be configured to retain a volume of insect repellent solution 2020. The blade 2015 can be rotatably coupled with the cover 2010, and the cover 2010 can be coupled with the vial 2005. The blade 2015 can include a blade end 2025 and a blade wicking member 2030. The blade end 2025 can be a cup or other curved member configured to capture air (e.g., wind, blowing air, etc.), where the captured air can cause the blade 2015 to rotate relative to the cover 2010. The wicking member 2030 can be a tube (e.g., slender and hollow member) or an absorbent member (e.g., absorbent string, membrane, sponge, etc.) that is configured to become at least partially saturated with insect repellent solution 2020 that is drawn up through the cover 2010 to the wicking member 2030. For example, the cover 2010 can include a wick, shown as wick tube 2035, that can be in fluid communication with the wicking member 2030 such that insect repellent can flow from the vial 2005 to the wicking member 2030 via the wick tube 2035. The wicking member 2030 can be configured to allow insect repellent solution 2020 to reach the blade end 2025, whether by gravitational force, centrifugal force (e.g., as the blade 2015 rotates relative to the cover 2010), etc. The blade 2015 can be configured to rotate via air flow captured by the blade end 2025. In another example, the cover 2010 can include a rotational spring (e.g., hand-wound spring motor) that, when wound, can cause the blade to rotate relative to the cover 2010 via a rotation spring force. In another example, the cover 2010 can include another motor device (e.g., small electric motor, photoelectric motor, etc.) that can be configured to receive power from a small solar panel.

In some examples, the rotation of the blade 2015 can draw (e.g., suck, pull, pump, etc.) insect repellent solution up through the wick tube 2035 through the cover 2010 to the wicking member 2030 and to the blade end 2025. Insect repellent solution 2020 at the blade end 2025 can be dispersed into the air (e.g., vaporize, evaporate, etc.) as enters and/or exits the blade end 2025 during rotation of the blade 2015, according to one example. In one example, the cover 2010 of the device 2000 can be rotatably coupled with the vial 2005 and can rotate between an open position and a closed position. In the closed position, the cover 2010 can prevent the wick tube 2035 from providing insect repellent solution from the vial 2005 to the wicking member 2030 of the blade 2015. In the open position, insect repellent solution can flow from the vial 2005 to the wicking member 2030 via the wick tube 2035. The vial 2005 can be refillable, according to one example. More specifically, the cover 2010 can be removed from the vial 2005 to allow a user to deposit additional insect repellent solution 2020 into the vial 2005.

In some examples, the device 2000 can further include a base where the cover 2010 is coupled to the base. In such examples, the vial 2005 can be coupled with the cover 2010 above the base and can drip insect repellent solution 2020 to the blade 2015 (e.g., via gravitational force), where the insect repellent can wick out to the blade end 2025. In this example, the cover 2010 can rotate relative to the base between an open position and a closed position. In the closed position, the cover 2010 can prevent the wick tube 2035 from dripping insect repellent solution 2005 to the wicking member 2030 of the blade 2015. In the open position, insect repellent solution within the vial 2005 can flow to the wicking member 2030 via the wick tube 2035. The vial 2005 can be removed from the cover 2010 to allow the vial to be refilled with insect repellent solution 2020. The base can include a solar panel to power the rotation of the blade 2015, according to one example.

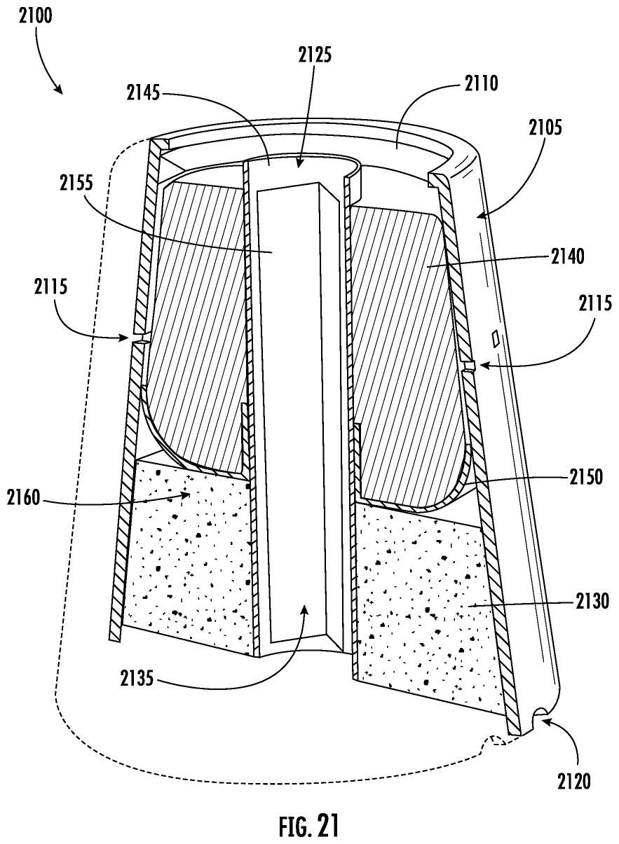

Referring now to FIG. 21, a non-powered insect repellent device 2100 is shown. The non-powered insect repellent device 2100 can include a housing 2105. The housing 2105 can be or include a foam cover or shroud defining an interior cavity 2160. The housing 2105 can be or include a thermally insulative material. The housing 2105 can include a top 2110, at least one first vent aperture 2115, and at least one second vent aperture 2120. The top 2110 of the housing 2105 can define an aperture 2125. For example, the aperture 2125 can extend through a center of the top 2110 of the housing in a vertical direction. The non-powered insect repellent device 2100 can also include a base 2130 and a heating element 2140. The base 2130 can be or include a foam material positioned within the interior cavity 2160 of the housing. For example, the base 2130 can be spaced apart from the top 2110 of the housing 2105. The base 2130 can define an aperture 2135. The aperture 2135 can define a central axis that is concentric with a central axis defined by the aperture 2125 defined by the top 2110. For example, the aperture 2125 and the aperture 2135 can be concentric.

The heating element 2140 can include a chemical compound configured to generate heat via an exothermic reaction when exposed to air or oxygen. For example, the heating element 2140 can include a thermal powder that generates heat via an exothermic reaction when exposed to oxygen. The heating element 2140 can include hydrogel material (e.g., hydrogel beads). For example, the heating element 2140 can include a mixture of thermal powder and hydrogel beads, where the hydrogel beads can increase a maximum temperature of the heating element 2140 during an exothermic reaction or maintain a particular temperature (e.g., 70° C.) for a prolonged period of time (e.g., 3.5 hours, 1-5 hours). The hydrogel beads can contain a liquid that evaporates after a certain amount of heat exposure. The heating element 2140 can be cylindrical or frustoconical and can define an aperture that is concentric or coaxial with the aperture 2125 or the aperture 2135. The heating element 2140 can be exposed to air via the first aperture 2115 to facilitate the exothermic reaction. The first aperture 2115 can be covered with a removable cover that prevents air from flowing through the first aperture 2115 until the cover is removed, for example. The exothermic reaction of the heating element 2140 can be increased by increasing exposure of the heating element 2140 to air. For example, the device 2100 can include multiple first apertures 2115, or a first aperture 2115 of a relatively large size (e.g., approximately as large as the aperture 2125 or 2135) to allow an increased volume of air to reach the heating element 2140 to facilitate the exothermic reaction. Increasing a volume of air flow to the heating element 2140 can increase a rate of an exothermic reaction (e.g., cause the heating element 2140 to reach a maximum or desired temperature quicker) or increase the maximum temperature of the heating element during the exothermic reaction, according to an embodiment.

The non-powered insect repellent device 2100 can include a tray 2150. The tray 2150 can be positioned between the heating element 2140 and the base 2130. The tray 2150 can be or include a metallic material that is thermally reflective. For example, the tray 2150 can prevent or reduce a transfer of heating energy from the heating element 2140 to the base 2130 during an exothermic reaction associated with the heating element 2140. The tray 2150 can support (e.g., hold, retain, capture) a thermal powder or hydrogel beads of the heating element 2140, according to an example. The non-powered insect repellent device 2100 can include a chimney 2145. The chimney 2145 can be a cylinder or tube that is disposed within the aperture 2125, the aperture 2135, and the aperture defined by the heating element 2140. The chimney 2145 can facilitate the flow of air through the aperture 2135 of the base 2130, through the aperture defined by the heating element 2140, and through the aperture 2125 of the top 2110. More specifically, air can be drawn into the chimney 2145 via the second aperture 2120 defined by the housing 2105 and positioned proximate the base 2130. Increasing a volume of air drawn into the chimney 2145 can facilitate a temperature increase of the heating element 2140, according to an embodiment. To increase the airflow through the chimney 2145, the device 2100 can include at least one stand or at least one leg to elevate the base 2130 of the device 2100 above a surface. For example, the device 2100 can be set on a surface (e.g., a table, a ground surface, etc.) via a leg, where the legs create a space (e.g., one cm, one inch, two inches, etc.) between the base 2130 or the aperture 2135 and the surface to allow air to flow through the chimney 2145 without obstruction or at an increased volume. Increasing a volume of air flowing through the chimney 2145 can increase a rate of the exothermic reaction or increase a maximum temperature of the exothermic reaction. The chimney 2145 can be or include a conductive element that can be configured conduct heat as the heating element 2140 generates heating energy via an exothermic reaction. For example, the chimney 2145 can conduct heat to heat the conduit defined by the aperture 2135 and the aperture 2125. The chimney 2145 can be aluminum, copper, or some other thermally conductive material, according to one example. As the heating element 2140 generates heating energy, air can be drawn into the chimney 2145 and can be warmed as it passes through the chimney 2145 and out the top 2110 of the housing.

An insect repellent element 2155 can be positioned within the chimney 2145. For example, the insect repellent element 2155 could be a wicking material saturated or partially saturated with an insect repellent chemical solution. The insect repellent solution can be heat-activated or can dissipate with heat and air flow. For example, the insect repellent solution can be volatilized as warm air (e.g., air that has been warmed by the heating element 2140) flows through the chimney 2145. As the warmed air passes through the chimney 2145 and out the top 2110, the insect repellent solution can be dispersed into the environment to repel insects. As indicated above, the housing 2105 can include a thermally insulative material configured to retain heat within the interior cavity 2160 of the housing 2105. By insulating heat within the cavity 2160 of the housing 2105, an elevated temperature can be maintained within cavity 2160 even as an exothermic reaction associated with a heating element 2140 slows (e.g., if the heating element 2140 is consumed). The insect repellent device 2100 can emanate additional insect repellent solution even after the heating element 2140 is consumed because of the elevated temperature within the cavity 2160 resulting from the thermally insulative housing 2105, for example.

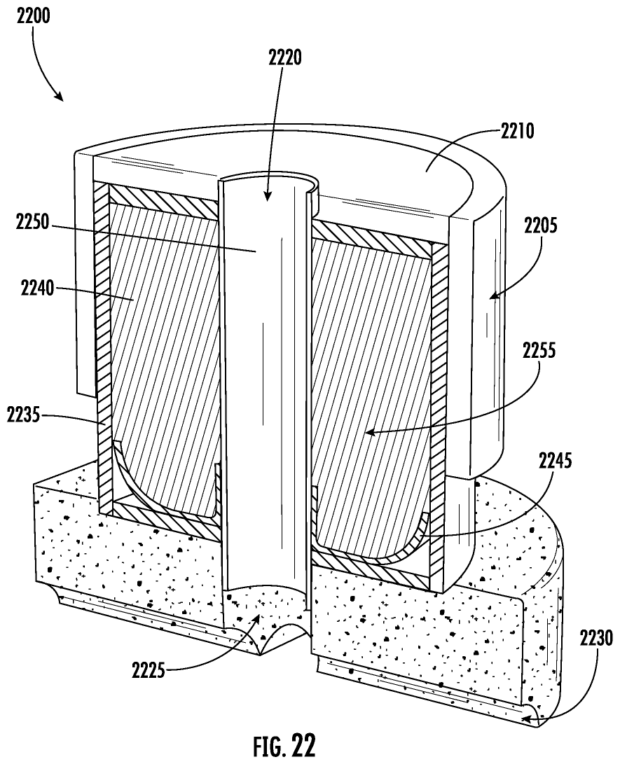

Referring now to FIG. 22, a non-powered insect repellent device 2200 is shown. The non-powered insect repellent device 2200 can be configured to disperse an insect repellent chemical in response to an exothermic reaction of a heating element. The non-powered insect repellent device 2200 can include a housing 2205. The housing 2205 can be or include a cover or shroud defining an interior cavity 2255. The housing 2205 can be or include a thermally insulative material. The housing 2205 can include a top 2210. The top 2210 can be or include a rubber material, a composite material, an organic material, a metallic material, or a thermally insulative material, for example. In some examples, the top 2210 can be a separate component from the housing 2205 such that the top 2210 and the housing 2205 are coupled together but not integrally formed. In other examples, the top 2210 can be integrally formed with the housing 2205. The top 2210 can define an aperture 2220. For example, the aperture 2220 can extend through a center of the top 2210 of the housing in a vertical direction.

The non-powered insect repellent device 2220 can also include a base 2215. The base 2215 can be or include a foam material positioned underneath the housing 2205 and the heating element 2240, for example. In some examples, the base 2215 can be positioned within the interior cavity 2255 defined by the housing 2205. The base 2215 can be spaced apart from the top 2210 of the housing 2205. The base 2215 can define a first aperture 2225 and a second aperture 2230. The first aperture 2225 can define a central axis that is concentric with a central axis defined by the aperture 2220 defined by the top 2210. For example, the aperture 2220 and the aperture 2225 can be concentric. The second aperture 2230 can extend through the base 2215 in a direction that is substantially perpendicular (e.g., ±30° from perpendicular) to the first aperture 2225. The second aperture 2230 can allow air to flow from an external environment into the first aperture 2225.

The non-powered insect repellent device 2200 can include a heating element 2240. The heating element 2240 can include a chemical compound configured to generate heat via an exothermic reaction when exposed to air or oxygen. For example, the heating element 2240 can include a thermal powder that generates heat via an exothermic reaction when exposed to oxygen. The heating element 2240 can include hydrogel material (e.g., hydrogel beads). For example, the heating element 2240 can include a mixture of thermal powder and hydrogel beads, where the hydrogel beads can increase a maximum temperature of the heating element 2240 during an exothermic reaction or maintain a particular temperature (e.g., 70° C.) for a prolonged period of time (e.g., 3.5 hours, 1-5 hours). The hydrogel beads can contain a liquid that evaporates after a certain amount of heat exposure. The heating element 2240 can be cylindrical, frustoconical, or some other shape, and can define an aperture that is concentric or coaxial with the aperture 2220 or the aperture 2225. The non-powered insect repellent device 2200 can also include a ventilation element 2235. The ventilation element 2235 can be a porous layer, membrane, or container that holds (e.g., retains, collects, supports) the heating element 2240. For example, the ventilation element 2235 can allow air to flow from an external environment to the heating element 2240 to facilitate an exothermic reaction. The ventilation element 2235 can be covered with a removable cover that prevents air from flowing through the ventilation element 2235 until the cover is removed, for example. In some embodiments, the base 2205 can slide relative to the ventilation element 2235 and the 2215 to expose the ventilation element 2235 to air.

The non-powered insect repellent device 2200 can include a tray 2245. The tray 2245 can be positioned between the heating element 2240 and the ventilation element 2235, for example. The tray 2245 can be or include a metallic material that is thermally reflective. For example, the tray 2245 can prevent or reduce a transfer of heating energy from the heating element 2240 to the base 2215 during an exothermic reaction associated with the heating element 2240. The tray 2245 can support (e.g., hold, retain, capture) a thermal powder or hydrogel beads of the heating element 2240, according to an example. The non-powered insect repellent device 2200 can include a chimney 2250. The chimney 2250 can be a cylinder or tube that is disposed within the aperture 2220, the aperture 2225, and the aperture defined by the heating element 2240. The chimney 2250 can facilitate the flow of air through the aperture 2225 of the base 2215, through the aperture defined by the heating element 2240, and through the aperture 2220 of the top 2210. More specifically, air can be drawn into the chimney 2250 via the second aperture 2230 defined by the base 2215, where the second aperture 2230 is in fluid communication with the first aperture 2225 of the base. As the heating element 2240 generates heating energy, air can be drawn into the chimney 2250 and can be warmed as it passes through the chimney 2250 and out the top 2210 of the housing.

An insect repellent element can be positioned within the chimney 2250. In some examples, the chimney 2250 can comprise the insect repellent element. The insect repellent element could be a wicking material saturated or partially saturated with an insect repellent chemical solution. The insect repellent solution can be heat-activated or can dissipate with heat and air flow. For example, the insect repellent solution can be volatilized as warm air (e.g., air that has been warmed by the heating element 2240) flows through the chimney 2250. As the warmed air passes through the chimney 2250 and out the top 2210, the insect repellent solution can be dispersed into the environment to repel insects.

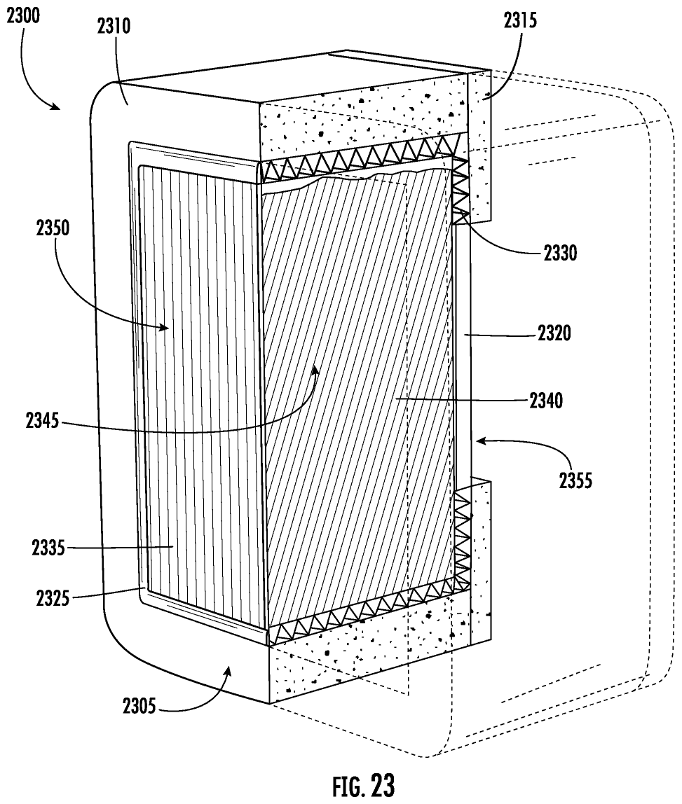

Referring now to FIG. 23, a non-powered insect repellent device 2300 is shown. The non-powered insect repellent device 2300 can be configured to disperse an insect repellent chemical in response to an exothermic reaction of a heating element. The non-powered insect repellent device 2300 can include a housing 2305. The housing 2305 can be or include a cover or shroud defining an interior cavity 2345. The housing 2305 can be or include a thermally insulative material. The housing 2305 can include a first side 2310 and a second side 2315. The first side 2310 can define a first opening 2350 into the interior cavity 2345. The second side 2315 can define a second opening 2355 into the interior cavity 2345. The first opening 2350 can be the same size or a different size than the second opening 2355. The housing 2305, the first side 2310, and the second side 2315 can be or include a foam material or other material. For example, the housing 2305, the first side 2310, and the second side 2315 can include a thermally insulative material. In some examples, the first side 2310 or the second side 2315 can be a separate component from the housing 2305 such that the first side 2310 and the second side 2315 can be coupled with the housing 2305 but not integrally formed therewith. In other examples, the first side 2310 or the second side 2315 can be integrally formed with the housing 2305.

The non-powered insect repellent device 2300 can include an interior support member 2330. For example, the interior support member 2330 can be disposed within the cavity 2345 and can provide structural support for the insect repellent device 2300. The support member 2330 can be or include a corrugated box, according to one example. In another example, the support member 2330 can be made of a plastic material, a metallic material, a composite material, an organic material, or some other material. In various examples, the support member 2330 can be semi-rigid or rigid in order to bolster the structural integrity of the device 2300. The non-powered insect repellent device 2300 can also include a thermally conductive layer 2325. The thermally conductive layer 2325 can be positioned within the first opening 2350 in the first side 2310 of the housing 2305. The thermally conductive layer 2325 can be a thermally conductive layer that can conduct heat from warmer elements positioned proximate to the thermally conductive layer 2325. For example, the thermally conductive layer 2325 can be a metallic layer (e.g., aluminum, copper, etc.) that can disperse heat evenly across the thermally conductive layer 2325.

The non-powered insect repellent device 2300 can include a heating element 2340. The heating element 2340 can include a chemical compound configured to generate heat via an exothermic reaction when exposed to air or oxygen. For example, the heating element 2240 can include a thermal powder that generates heat via an exothermic reaction when exposed to oxygen. The heating element 2240 can include hydrogel material (e.g., hydrogel beads). For example, the heating element 2240 can include a mixture of thermal powder and hydrogel beads, where the hydrogel beads can increase a maximum temperature of the heating element 2240 during an exothermic reaction or maintain a particular temperature (e.g., 70° C.) for a prolonged period of time (e.g., 1 hour, 1-5 hours). The hydrogel beads can contain a liquid that evaporates after a certain amount of heat exposure. The heating element 2340 can be positioned within the cavity 2345 of the housing 2305. For example, the heating element 2340 can be positioned within the interior support member 2330. The thermally conductive layer 2325 can be positioned to one side of the heating element 2340. For example, the thermally conductive layer 2325 can be positioned within the first opening 2350 of the first side 2310. The non-powered insect repellent device 2300 can also include a ventilation element 2320. The ventilation element 2320 can be positioned within the second opening 2355 formed within the second side 2315. The ventilation element 2320 can be positioned between the heating element 2340 and an external environment, for example. The ventilation element 2320 can be a porous layer, membrane, or container that can allow air to flow from an external environment to the heating element 2340 to facilitate an exothermic reaction. The ventilation element 2320 can be covered with a removable or movable cover that prevents air from flowing through the ventilation element 2235 until the cover is removed, for example.

The non-powered insect repellent device 2300 can include an insect repellent element 2335. The insect repellent element 2335 could be a wicking material saturated or partially saturated with an insect repellent chemical solution. The insect repellent element 2335 can be positioned adjacent to or against the thermally conductive layer 2325. The insect repellent element 2335 can be positioned within the first opening 2350 of the first side 2310. The insect repellent solution can be heat-activated or can dissipate with heat and air flow. For example, the heating element 2340 can generate heating energy when exposed to air. The heating energy can warm the thermally conductive layer 2325 that is positioned proximate (e.g., adjacent to, against) the heating element 2340. The heating element 2340 and the thermally conductive layer 2325 that has been warmed by the heating element 2340 can heat the insect repellent element 2335 and the surrounding air, for example. The insect repellent solution can be volatilized as warm air (e.g., air that has been warmed by the heating element 2340) flows past the insect repellent element 2335. As the warmed air passes over the insect repellent element, the insect repellent solution can be dispersed into the environment to repel insects.

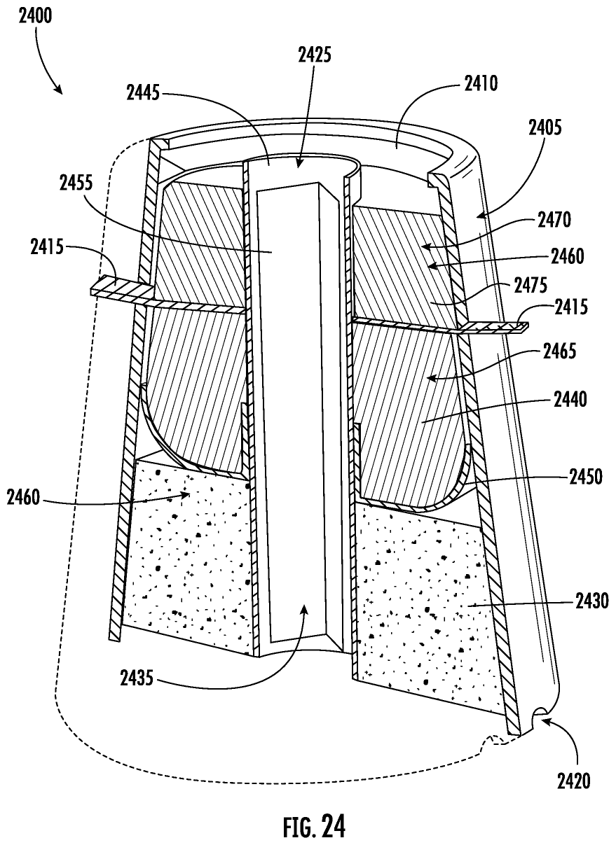

Referring now to FIG. 24, a non-powered insect repellent device 2400 is shown. The non-powered insect repellent device 2400 can include a housing 2405. The housing 2405 can be or include a foam cover or shroud defining an interior cavity 2460. The cavity can define a first chamber 2465 and a second chamber 2470. The first chamber 2465 can be separated from the second chamber 2470 by a partition 2415. The partition 2415 can be a removable partition. For example, the partition 2415 can be accessible from outside of the housing 2405 by a user. The user can pull or remove the partition 2415, where the first chamber 2465 can be joined (e.g., not separated from) the second chamber 2470 with the partition 2415 removed. The housing 2405 can be or include a thermally insulative material. The housing 2405 can include a top 2410 and at least one first opening 2420. The top 2410 of the housing 2405 can define an aperture 2425. For example, the aperture 2425 can extend through a center of the top 2410 of the housing in a vertical direction. The non-powered insect repellent device 2400 can also include a base 2430, a heating element 2440, and an activant element 2475. The base 2430 can be or include a foam material positioned within the interior cavity 2460 of the housing. For example, the base 2430 can be spaced apart from the top 2410 of the housing 2405. The base 2430 can define an aperture 2435. The aperture 2435 can define a central axis that is concentric with a central axis defined by the aperture 2425 defined by the top 2410. For example, the aperture 2425 and the aperture 2435 can be concentric. The aperture 2425 and the aperture 2435 can collectively define a conduit that allows air to flow from the first opening 2420 (which can be positioned proximate a bottom of the housing 2405) through the aperture 2435, through the aperture 2425, and out the top 2410 of the device 2400.

The heating element 2440 can be positioned within the first chamber 2465. The activant element 2475 can be positioned within the second chamber 2470. The heating element 2440 can be separated from the activant element 2475 with the partition located between the first chamber 2465 and the second chamber 2470. The heating element 2440 can include a chemical compound configured to generate heat via an exothermic reaction when exposed an activant substance, such as the activant element 2475. For example, the heating element 2440 can include a thermal powder that generates heat via an exothermic reaction when exposed to an activant such as water, glycerol, or some other substance. As indicated above, the partition 2415 between the first chamber 2465 and the second chamber 2470 can be removable. The heating element 2440 and the activant element 2475 can be mixed (e.g., contact each other, commingle, etc.) with the partition 2415 removed. The heating element 2440 can be activated via the activant element 2475 with the partition 2415 removed. An exothermic reaction can result when the heating element 2440 is exposed to the activant. The first chamber 2465 and the second chamber 2470 can be positioned adjacent each other such that the heating element 2440 and the activant element 2475 mix with the removal of the partition 2415 (e.g., no other mixing is required). In other examples, the activant element 2475 and the heating element 2440 can also be mixed by shaking, squeezing, spinning the device 2400, or otherwise manipulating the device 2400 to cause the heating element 2440 and the activant element 2475 to mix. In other examples, the partition 2415 is not removeable, but is instead a breakable seal or barrier. For example, the partition 2415 can be a foil barrier that, once pierced, can allow the activant element 2475 and the heating element 2440 to mix. In another example, the partition 2415 can be a barrier that can be broken by force (e.g., by squeezing the device 2400) to cause the heating element 2440 and the activant element 2475 to mix.

The heating element 2440 can include hydrogel material (e.g., hydrogel beads). For example, the heating element 2440 can include a mixture of thermal powder and hydrogel beads, where the hydrogel beads can increase a maximum temperature of the heating element 2440 during an exothermic reaction or maintain a particular temperature (e.g., 70° C.) for a prolonged period of time (e.g., 3.5 hours, 1-5 hours). The hydrogel beads can contain a liquid that evaporates after a certain amount of heat exposure. The heating element 2440 can be cylindrical or frustoconical and can define an aperture that is concentric or coaxial with the aperture 2425 or the aperture 2435. The activant element 2475 can be cylindrical or frustoconical and can define an aperture that is concentric or coaxial with the aperture 2425 or the aperture 2435.

The non-powered insect repellent device 2400 can include a tray 2450. The tray 2450 can be positioned between the heating element 2440 and the base 2430. The tray 2450 can be or include a metallic material that is thermally reflective. For example, the tray 2450 can prevent or reduce a transfer of heating energy from the heating element 2440 to the base 2430 during an exothermic reaction associated with the heating element 2440. The tray 2450 can support (e.g., hold, retain, capture) a thermal powder or hydrogel beads of the heating element 2440, according to an example. The non-powered insect repellent device 2400 can include a chimney 2445. The chimney 2445 can be a cylinder or tube that is disposed within the aperture 2425, the aperture 2435, and the aperture defined by the heating element 2440. The chimney 2445 can facilitate the flow of air through the aperture 2435 of the base 2430, through the apertures defined by the heating element 2440 and activant element 2475, and through the aperture 2425 of the top 2410. More specifically, air can be drawn into the chimney 2445 via the second aperture 2420 defined by the housing 2405 and positioned proximate the base 2430. The chimney 2445 can be or include a conductive element that can be configured conduct heat as the heating element 2440 generates heating energy via an exothermic reaction. For example, the chimney 2445 can conduct heat to heat the conduit defined by the aperture 2435 and the aperture 2425. The chimney 2445 can be aluminum, copper, or some other thermally conductive material, according to one example. As the heating element 2440 generates heating energy, air can be drawn into the chimney 2445 and can be warmed as it passes through the chimney 2445 and out the top 2410 of the housing.

An insect repellent element 2455 can be positioned within the chimney 2445. For example, the insect repellent element 2455 could be a wicking material saturated or partially saturated with an insect repellent chemical solution. The insect repellent solution can be heat-activated or can dissipate with heat and air flow. For example, the insect repellent solution can be volatilized as warm air (e.g., air that has been warmed by the heating element 2440) flows through the chimney 2445. As the warmed air passes through the chimney 2145 and out the top 2410, vaporized insect repellent solution can be dispersed into the environment to repel insects.

Although this description may discuss a specific order of method steps, the order of the steps may differ from what is outlined. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

It is important to note that the construction and arrangement of the electromechanical variable transmission as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. An non-powered insect repellent device, comprising:
a heating element comprising a chemical compound configured to generate heating energy via an exothermic reaction;
a removable cover coupled with a portion of the heating element, wherein the portion of the heating element is configured to be exposed to air with the removable cover at least partially removed from the heating element;
an insect repellent element configured to emanate insect repellent solution in response to the heating energy; and
a housing defining a cavity, a first opening, and a second opening, wherein air flows through the first opening to the heating element, and wherein the housing is configured to provide vaporized insect repellent solution through the second opening.

2. The device of claim 1, wherein the housing defines a plurality of first openings to provide air to the heating element with the removable cover at least partially removed.

3. The device of claim 1, further comprising:
a third opening fluidly coupled with the second opening to define a conduit, the conduit configured to allow air to flow from the third opening to the second opening to provide vaporized insect repellent solution through the second opening.

4. The device of claim 1, wherein the second opening is positioned proximate a top of the housing, the device further comprising:
a third opening positioned proximate a bottom of the housing and fluidly coupled with the second opening to define a conduit, the conduit configured to allow air to flow from the third opening to the second opening to provide vaporized insect repellent solution through the second opening.

5. The device of claim 1, further comprising:
a third opening fluidly coupled with the second opening to define a conduit, the conduit configured to allow air to flow from the third opening to the second opening to provide vaporized insect repellent solution through the second opening; and
a conductive liner positioned within the conduit and adjacent to the heating element, the conductive liner to conduct the heating energy within the conduit.

6. The device of claim 1, further comprising:
a third opening fluidly coupled with the second opening to define a conduit, the conduit configured to allow air to flow from the third opening to the second opening to provide vaporized insect repellent solution through the second opening; and
a conductive liner positioned within the conduit and adjacent to the heating element, the conductive liner to conduct the heating energy within the conduit.

7. The device of claim 1, further comprising:
a third opening fluidly coupled with the second opening to define a conduit, the conduit configured to allow air to flow from the third opening to the second opening to provide vaporized insect repellent solution through the second opening; and
a conductive liner positioned within the conduit and adjacent to the heating element, the conductive liner to conduct the heating energy within the conduit,
wherein the insect repellent element comprises a wicking material at least partially saturated with insect repellent solution, the wicking material positioned within the conductive liner.

8. The device of claim 1, wherein the housing comprises a thermally insulative material.

9. The device of claim 1, wherein the exothermic reaction does not occur with the removable cover positioned over the first opening.

10. The device of claim 1, the heating element further comprising a thermal material and a hydrogel material, the hydrogel material configured to increase a maximum temperature of the exothermic reaction.

11. An non-powered insect repellent device, comprising:
a housing defining a first opening fluidly coupled with a second opening and a cavity, the cavity including a first chamber separated from a second chamber;
an activant element positioned within the first chamber;
a heating element positioned within the second chamber, the heating element comprising a chemical compound configured to generate heating energy via a chemical reaction with the activant element; and
an insect repellent element configured to emanate insect repellent solution in response to the heating energy, wherein air flows from the first opening to the second opening to provide vaporized insect repellent solution through the second opening.

12. The device of claim 11, further comprising:
a removable partition separating the first chamber and the second chamber, wherein the heating element and the activant element are at least partially mixed with the partition removed.

13. The device of claim 11, further comprising:
a removable partition separating the first chamber and the second chamber, wherein the partition is accessible from an outer surface of the housing to remove the partition, wherein the heating element and the activant element are at least partially mixed with the partition removed.

14. The device of claim 11, further comprising:
a partition separating the first chamber and the second chamber, wherein the partition is configured to be broken to mix the heating element and the activant element.

15. The device of claim 11, wherein the first opening and the second opening define a conduit, the device further comprising:
a conductive liner positioned within the conduit and adjacent to the heating element, the conductive liner to conduct the heating energy within the conduit.

16. The device of claim 11, wherein the first opening and the second opening define a conduit, the device further comprising:
a conductive liner positioned within the conduit and adjacent to the heating element, the conductive liner to conduct the heating energy within the conduit,
wherein the insect repellent element comprises a wicking material at least partially saturated with insect repellent solution, the wicking material positioned within the conductive liner.

17. A non-powered insect repellent device, comprising:
a housing including defining a cavity and at least one opening;
a heating element positioned within the cavity, the heating element comprising a thermal material and a hydrogel material, the heating element configured to generate heating energy via a chemical reaction with an activant; and
an insect repellent element positioned within the cavity and proximate the at least one opening, the insect repellent element configured to emanate insect repellent vapor in response to the heating energy,
wherein the device is configured for one-time use.

18. The device of claim 17, wherein the activant is air, the device further comprising:
a removable cover positioned over a conduit in fluid communication with the heating element, wherein removing the removable cover allows air to flow to the heating element to initiate the chemical reaction.

19. The device of claim 17, wherein the activant is air, the device further comprising:
a top portion of the housing rotatably coupled with a bottom portion of the housing, wherein rotating the top portion relative to the bottom portion provides allows air to flow to the heating element to initiate the chemical reaction.

20. The device of claim 17, wherein the housing includes a top portion rotatably coupled with a bottom portion, the device further comprising:
an activant element positioned within the cavity, wherein rotating the top portion relative to the bottom portion causes the activant element to mix with the heating element to initiate the chemical reaction.
